(19) United States
(12) Patent Application Publication
(10) Pub. No.: US 2012/0246170 A1
(43) Pub. Date: Sep. 27, 2012

(54) MANAGING COMPLIANCE OF DATA INTEGRATION IMPLEMENTATIONS

(75) Inventor: Daniel M. Iantorno, Oak Park, IL (US)

(73) Assignee: Momentum Consulting, Oak Park, IL (US)

(21) Appl. No.: 13/053,594

(22) Filed: Mar. 22, 2011

(51) Int. Cl. G06F 17/30

(52) U.S. Cl. 707/748; 707/E17.071

(57) ABSTRACT

A system and associated processes which permit organizations to objectively evaluate compliance levels for data integration implementations and other application development platforms. An implementation scorecard analytics feature is provided to the user to permit analysis and computation of a score representing a level of maturity and/or compliance of the code being analyzed. Also disclosed are a system and process for evaluating mapping complexity in a data integration implementation and a transformation, session, and workflow attribute configuration management system, which provides a more granular level reporting for transformation, session, and workflow attributes to diagnose variations in implementations.

### FIELD OF THE INVENTION

The present invention relates to the field of application development, including development of data integration applications. More specifically, the invention relates to systems and processes for managing compliance of application development with standards, best practices and other quality guidelines.

### BACKGROUND OF THE INVENTION

Computers are in widespread use to perform a variety of tasks by running or executing applications in business organizations of virtually every type. The general function of applications is to process data, which is either input by a user or retrieved from a local or remote database. As organizations and applications become more complex, the volume of data to be processed and the disparity in data forms across an organization also increases. Thus, it becomes increasingly difficult for organizations to manage and extract value from data.

An example, one can imagine the data management challenges of an online Internet retailer with a worldwide customer base. Each customer has a profile of buying history, preferences and other data that the retailer desires to track for purposes of recognizing trends and patterns in customer buying. Thus, for a customer base of millions of customers, the volume of raw data may be extremely large. The retailer may store this raw data in one or more databases and typically desires to have the ability to perform sophisticated analysis to enable the retailer to make better decisions on how to better manage its company and serve its customers throughout the world.

Data integration involves combining data from different sources to make data more useful, and therefore more valuable, within an organization. Data integration typically involves extracting raw data from one or more operational databases and transforming it into a more useful form. In a typical organization, transformation of data is driven primarily by the business processes defined in the organization. For example, the organization's marketing department may have an entirely different process for leveraging the data as compared to the organization's accounting department.

Organizations typically employ commercial data integration platforms to address their data integration needs. One such platform is the PowerCenter® Suite offered by Informatica® Corporation of Redwood City, Calif. These platforms typically offer scalability and provide a number of capabilities useful for data integration and allow an organization to develop and deploy data integration applications. With reference to FIG. 1A, such systems may include a repository management application, used by administrators to manage users, permissions, and current application connections and locks on repository objects. A field mapping or data format design application may also be included to permit developers and development team leaders to build and review data integration applications. The platform may also include a workflow management application for allowing developers and development team leaders to build, review and execute a series of linked programs and tasks within an organized unit of work, also known as a workflow. A workflow monitoring application may also be included to allow all users to review, examine and monitor the status of all processes within a given repository environment and to allow users to review basic metrics about workflow execution and related tasks.

Referring to FIG. 1B, in large-scale organizations that develop and deploy a multitude of data integration applications, the data integration platform may include multiple server instances and supporting repositories. Moreover, data integration application development may occur according to industry-standard software development lifecycles, which typically involve a development environment, a system testing environment and a production environment. Thus, the repository management, mapping design, workflow management and workflow monitoring applications can access, develop and deploy code to multiple environments and multiple repositories.

Application development organizations often apply quality methodologies and best practices to carry out the design and development process in order to build in efficiencies and achieve repeatable success. Moreover, such organizations may adhere to standards and guidelines that are specifically applicable to the development process and to the quality of the resulting application code. As an example, Informatica has generated a development and implementation methodology—termed “Velocity”™—which is applicable to the data integration application development and deployment process.

While various quality management tools, such as the use of methodologies, best practices, standards, benchmarks and guidelines have been applied to the application development process, existing tools to monitor and measure the adherence to such quality management techniques by development teams typically involve a great deal of manual effort. For example, relating to the use of methodologies, typically comprehensive manual reviews of the development process and resulting code are required by highly-skilled experts. Needless to say, this can be expensive and time-consuming, not to mention prone to errors introduced in the manual reviews.

Thus, there is a need in the art for systems that provide organizations with the ability to efficiently evaluate compliance with application development standards, best practices and other quality measures. With particular regard to data integration implementations, there is thus a need for systems that provide users with the ability to quickly and objectively assess compliance of the implementation with particular standards. Such standards may be external to an organization, such as standards reflected in the Capability Maturity Model® Integration (CMMI®) standard, version 1.2, released by Carnegie Mellon University in 2006. CMMI® defines a business process improvement approach that helps organizations improve their performance. Alternatively, such standards may be internal and even proprietary to the organization. Accordingly, a satisfactory system for enhancing compliance management must be adaptable to both externally and internally-set standards, best practices and other quality measures.

In the context of data integration implementations, there exist standards and guidelines for writing code to accomplish data mappings, transformations and translations in an efficient and logical manner. Unnecessary complexity in any of these areas leads to inefficient use of resources. Existing tools do not enable a user to efficiently isolate compliance issues relating to code complexity in these areas. Complexity within a data integration system may be applicable to the business requirements of the application (measured by size and volume of data, frequency of load, security requirements, data transfer limitations, data formatting, etc.), the system architecture design, or the individual units of work within the overarching system. When these standards and guidelines are not adhered to properly, unnecessary complexity is introduced into the environment(s). Identifying unnecessary complexity prior to production implementation can lead to a variety of cost-savings measures which include (1) support and maintenance, (2) time spent unit testing and system integration testing, (3) reduced overall development cycles, etc. Thus, it would be advantageous to provide a system and process which enables organizations to quickly determine compliance issues relating to data mapping and other complexity.

Another shortcoming in the prior art relates to the area of transformation, session, and workflow attribute configuration reporting. Existing tools, such as Informatica®, do not enable a user to develop robust reports for transformation, session, and workflow attribute configurations. In addition, there exists no true cross-repository or cross-GUI metadata analysis for performance scorecards and benchmarking capabilities. Thus, it would be advantageous to provide a system for enabling an organization to obtain a more comprehensive and robust view of these attribute configurations across a data integration implementation.

### SUMMARY OF THE INVENTION

Described herein are techniques for addressing the shortcomings in the prior art, as explained above. More specifically, the invention provides a system and associated processes which permit organizations to objectively evaluate compliance levels for data integration implementations. The features of the invention are adaptable to data integration platforms, such as Informatica, as well as other data integration platforms. The invention provides a framework to support development teams, data integration project managers, and the administrators who support application development infrastructure. The invention permits organizations to avoid common development pitfalls, track the progress and quality of new development, and proactively identify process improvement areas. More specific advantages of the invention include: reducing the number of overall defects and bugs encountered during development cycles; eliminating errors that commonly occur during code migrations and deployments; facilitating the mapping and workflow performance enhancements and close adherence to project timelines and budgets. The invention also provides for the identification of units of data integration application code which are non-compliant with industry standards, difficult to test, support and maintain, and which represent potentially poor-performing technology components that may unnecessarily strain other resources in the data integration platform.

According to one aspect of the invention, a data integration implementation compliance scoring system and process are provided. The system and process provides an objective way to evaluate compliance levels. The system and process may include an implementation analytics wizard provided to the user to permit analysis and computation of a score representing a level of maturity and/or compliance of the code being analyzed.

According to another aspect of the invention, there is provided a system and process for evaluating mapping complexity in a data integration implementation. The mapping complexity evaluation can be used as part of the data integration implementation compliance scoring system described above.

In accordance with another aspect of the invention, there is provided a transformation, session, and workflow attribute configuration management system, which provides a more granular level reporting for transformation, session, and workflow attributes to diagnose variations in implementations. The invention provides a system for displaying transformation, session, and workflow attribute configurations, which facilitates rapid evaluation and comparison by a user desiring, for example, to provide for the querying of Designer tables and correlating data within the field mapping component to data within the Workflow Management tables in Informatica.

### BRIEF DESCRIPTION OF THE DRAWINGS

The features and attendant advantages of the invention will become apparent from consideration of the following detailed description together with the accompanying drawings, in which like reference numerals represent like elements. It will be understood that the description and embodiments are intended as examples to illustrate the invention and are not intended to be limiting to the scope of invention, which is set forth in the claims appended hereto.

FIGS. 1A and 1B, as discussed above, illustrate prior art application development environments suitable for supporting the inventive techniques discussed herein.

FIG. 2 illustrates an exemplary network-based environment suitable for an implementation of a system according to the present invention.

FIG. 3 illustrates an exemplary application interface diagram of a system according to the present invention.

FIG. 4 is a block diagram of an exemplary computer system suitable for implementing embodiments according to the present invention.

FIG. 5 shows an exemplary process for determining the level of adherence to a benchmark compliance management tool according to the present invention.

FIG. 6 illustrates an exemplary home or main screen for a compliance management application according to the invention.

FIG. 7 illustrates an exemplary process for an implementation compliance scorecard according to the invention.

FIG. 8 is an exemplary user interface for enabling a user to select subject matter areas for an implementation compliance scorecard application according to the invention.

FIG. 9 is an exemplary interface for enabling a user to select gradation categories associated with compliance factors according to a preferred embodiment of the invention.

FIG. 10 is an exemplary interface for enabling a user to select gradation categories associated with naming standard compliance factors.

FIG. 11 illustrates a compliance scoring computation according to a preferred embodiment of the invention.

FIG. 12 is a graphic depiction of an implementation scorecard according to a preferred embodiment of the invention.

FIG. 13A illustrates a mapping configuration in a prior art data integration platform mapping designer tool.

FIG. 13B is an exemplary graphical user interface for a mapping complexity scoring system according to a preferred embodiment of the invention.

FIGS. 14A and 14B illustrate a process for scoring mapping complexities according to a preferred embodiment of the invention.

FIG. 15 illustrates a “heat map” type graphic illustration of mapping complexity data according to the present invention.

FIGS. 16A and 16B illustrate a user input screen and a process, respectively, for manually retrieving transformation attribute information according to known prior art systems.

FIG. 17A illustrates a process for developing an integrated report of transformation widget and workflow attribute information according to an aspect of the invention.

FIG. 17B depicts an integrated transformation attribute display according to a preferred embodiment of the present invention.

FIG. 18 depicts a user interface for a transformation attribute management application according to a preferred embodiment of the invention.

FIG. 19 depicts another user interface for a transformation attribute management application according to a preferred embodiment of the invention.

FIGS. 20 and 21 illustrate a process for further customization of a compliance management process according to a preferred embodiment of the invention.

FIGS. 22 and 23 illustrate a process for utilizing encryption in in the context of a compliance management tool according to the present invention.

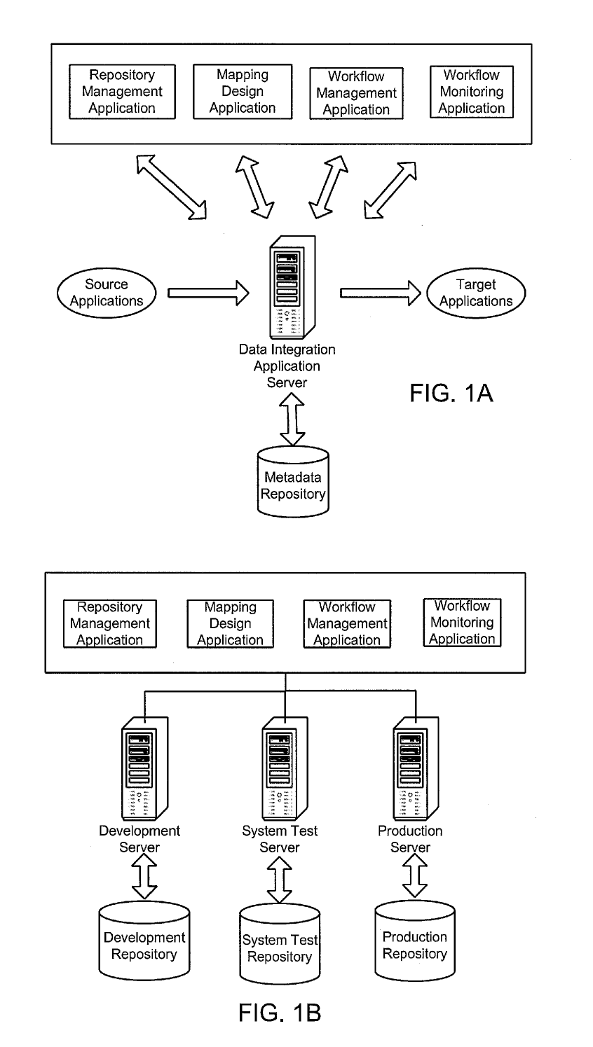

### DETAILED DESCRIPTION OF THE PRESENT EMBODIMENTS

It will be understood, and is appreciated by persons skilled in the art, that one or more processes, sub-processes, or process steps described in connection with the Figures included herewith may be performed by hardware and/or software. If the process is performed by software, the software may reside in software memory in a suitable electronic processing component or system such as, one or more of the functional components or modules schematically depicted in the Figures. The software in software memory may include an ordered listing of executable instructions for implementing logical functions (that is, “logic” that may be implemented either in digital form such as digital circuitry or source code or in analog form such as analog circuitry or an analog source such an analog electrical, sound or video signal), and may selectively be embodied in any computer-readable medium for use by or in connection with an instruction execution system, apparatus, or device, such as a computer-based system, processor-containing system, or other system that may selectively fetch the instructions from the instruction execution system, apparatus, or device and execute the instructions. In the context of this disclosure, a “computer-readable medium” is any means that may contain, store or communicate the program for use by or in connection with the instruction execution system, apparatus, or device. The computer readable medium may selectively be, for example, but is not limited to, an electronic, magnetic, optical, electromagnetic, infrared, or semiconductor system, apparatus or device. More specific examples, but nonetheless a non-exhaustive list, of computer-readable media would include the following: a portable computer diskette (magnetic), a RAM (electronic), a read-only memory “ROM” (electronic), an erasable programmable read-only memory (EPROM or Flash memory) (electronic) and a portable compact disc read-only memory “CDROM” (optical). Note that the computer-readable medium may even be paper or another suitable medium upon which the program is printed, as the program can be electronically captured, via for instance optical scanning of the paper or other medium, then compiled, interpreted or otherwise processed in a suitable manner if necessary, and then stored in a computer memory.

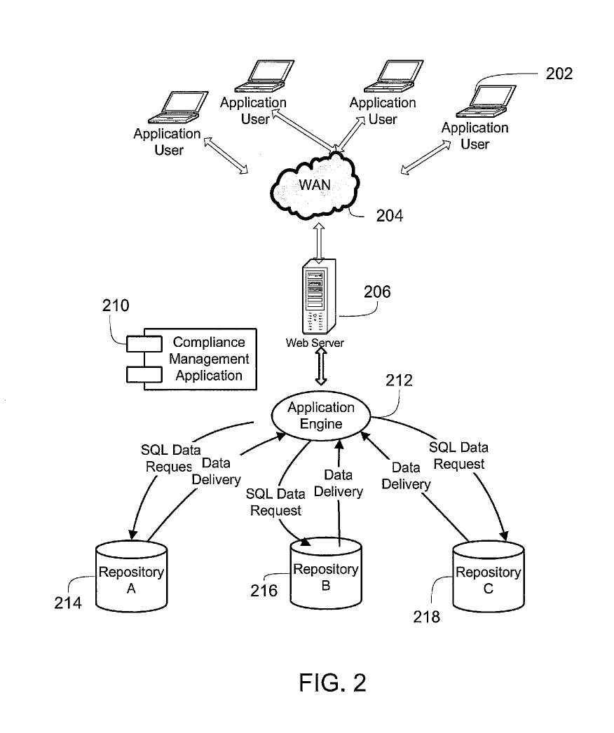

Referring now to FIG. 2, there is illustrated a network based environment suitable for supporting the features of the instant invention. More specifically, the environment supports a number of application user workstations 202 which permit users, through suitable administrative steps, as will be explained later, to access and execute a quality management application 210 provided according to the present invention. The environment will typically include a wide area network (WAN) 204 access by the application users via a network interface on their respective computing devices. Also networked to the WAN is a web server 206, which will typically support a number of applications, including a compliance management application 210 according to the present invention. An application engine 212 is also supported by the web server and operates to direct data requests and receive delivered data from the respective repositories 214, 216 and 218 in the data integration platform.

User access will typically occur through a web browser, such as Firefox or Internet Explorer. Each user will enter a specific URL which will send them to the logon page for the application. Username and password information will be routed to an internal storage mechanism (such as a flat file on disk space or a database table) for user authentication and validation.

Upon successful authentication, a user will be brought to the main welcome page. A portion of the page will be static information served to it via a series of files in directory structures. Other components of the page may be extracted directly from the underlying repository or repositories. Requests, which may typically be in the form of SQL data queries are sent to the respective repositories supported by the data integration platform. In response, data is delivered to the application engine, processed by the quality management application, served to the WAN via the web server, and displayed to the application users as will be further described herein.

Each new screen a user engages with will have this similar dynamic. Some information may remain static; other information will be dynamically generated via SQL code stored within a proprietary code file which has been encrypted for security. While the delivery of the data from the repository may vary, it is the SQL code that is used to retrieve the data which preferably provides the advantages according to an embodiment of the invention. Preferably, the database queries provide an the implicit conversion of an Online Transaction Processing (OLTP) structure into more of an Online Analytical Processing (OLAP) structure for reporting and analysis.

For some components of the application, users enter in user-specific variables and data points which can be incorporated into the SQL code and metrics calculations used within the application. This information will be stored in either flat file format or in a relational database structure for optimal query and storage purposes.

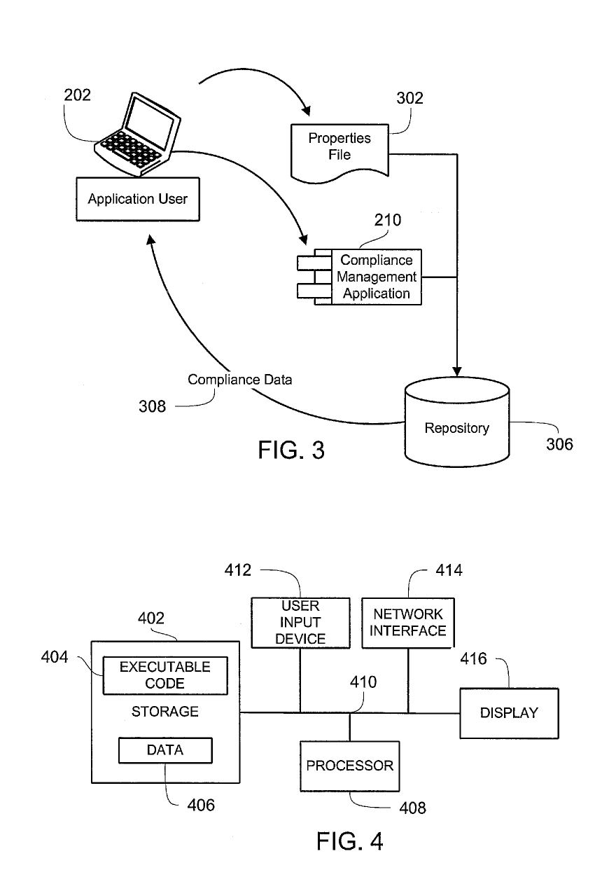

Referring to FIG. 3, the application interface includes a properties file 302, which stores information relating to various operating parameters of the compliance management application 210 and facilitates requests for data from the repository. The application user, via the computing device, interacts with the compliance management application 210, which in turn sends requests to the repository 306, typically using SQL queries developed by compliance management application 210 using information from the properties file 302. In response, transformed and/or aggregated compliance data 308 representing various compliance levels, as will be explained in further detail below, are sent to the application user.

FIG. 4 illustrates the components of an exemplary computing device suitable as a user workstation 202 or web server 206 (FIG. 2) for supporting features and functionality according to an embodiment of the present invention. The computing device includes storage or memory 402, which may include read-only memory and random-access memory, and which stores information representing executable instructions 404 and data 406 to be processed. A processor 408 communicates with the storage via a data bus 410 and executes the instructions stored in memory. Also communicating with the data bus 410 are one or more user input devices 412, which may include a keyboard and mouse, touch pad. Also in communication with the data bus 410 is a network interface component 414, suitable for allowing data communication with a network, such as a LAN or WAN. A display 416 is also in communication with the bus for displaying information to the user.

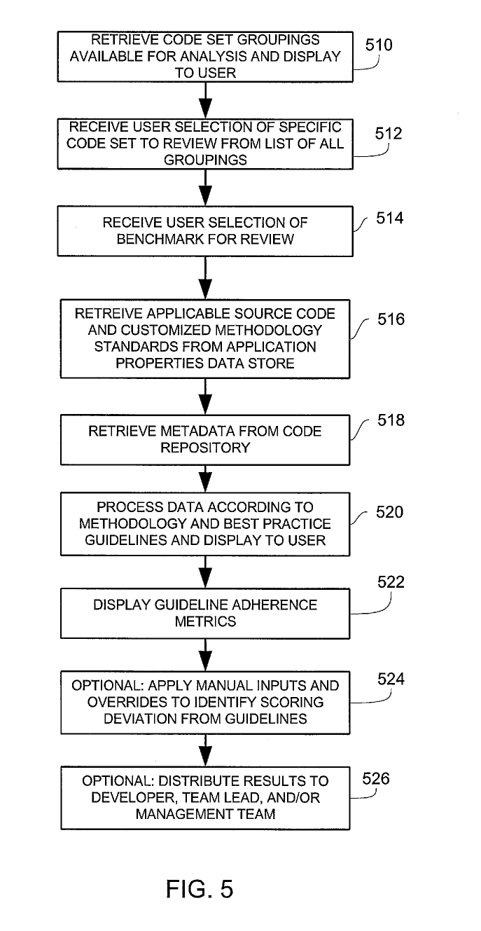

FIG. 5 illustrates a high-level process for determining the compliance level of a data integration implementation according to the present invention. At step 510, information representing code set groupings that are available for analysis is retrieved from the repository 214, 216, 218 (FIG. 2) and displayed to the user, for example, as a listing on the display screen 416. The code set groupings are code relating to a data integration application, for example. At step 512, the user selects one or more of the code set groupings for analysis and the computing device, in response, receives a signal or information indicating the user response. Similarly, at step 514, the user selects a particular benchmark or other quality management parameter from a listing on the display and the computing device receives a corresponding signal or information indicative of that event.

Still referring to FIG. 5, in response to user selection of the code set and benchmark, the computing device at step 516 retrieves the appropriate source code and benchmark, methodology and/or standards information from an application configuration properties data store 302, the details of which will be explained below. Also in response, at step 518, the data integration platform retrieves metadata from the repository. The code is then compared to the quality management parameter and the information representing the level of compliance is displayed to the user at step 520. Guideline compliance metrics may be displayed at step 522. Optional steps may include applying manual inputs and overrides to identify scoring deviations from accepted guidelines, as represented at step 524, and distribution of the results to development team leads, as represented at step 526.

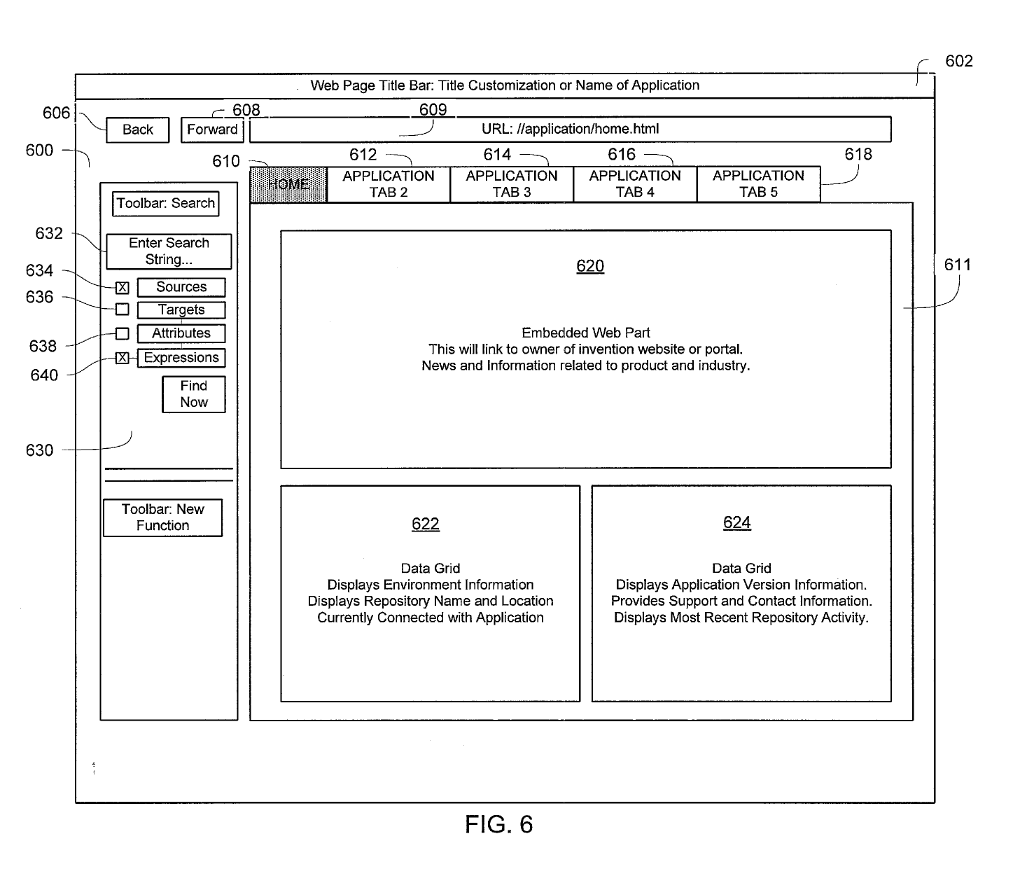

FIG. 6 illustrates an exemplary main or home screen displayed to the user for accessing compliance management application functionality according to the invention. As will be recognized in by those skilled in the art, the compliance management application 210 may be accessed through a web browser. The main screen 600 provides a title bar 602 indicating the application name to the user. A navigation bar 609 is provided for enabling entry of a URL corresponding to the network or internet location of the application server. Typically, back and forward navigation buttons 606 and 608 are also provided for navigating to previous or subsequent web pages. A “home” tab control 610 (shown in FIG. 6 as activated via a user input device) is provided to enable user navigation to a home panel 611. A number of additional tabs 612, 614, 616 and 618 may be provided and correspond to access tabs and/or instructional wizard-type interfaces for additional functionality, which may relate to code standards, mapping optimization, transformation attributes, directory structures, task attributes, connection details, user groups and execution statistics. The home panel 611 includes an embedded web partition 620 for displaying information from a web service hosted by a provider of the compliance management application according to the invention, including news and information that is relevant to users of the application. Also included in home panel 611 are a first and second data grid partition, 622 and 624. The first data grid partition 622 provides environment information and may display the name and location of one or more repositories currently connected with the application. The second data grid 624 may display application version information, provide support and contact information and may display recent repository activity. Also provided as part of the main screen 600 is a search toolbar 630 for enabling the user to search across repository data based on search strings entered in a search string entry pane 632 and further filtered by characteristics such as sources, targets, attributes or expressions by corresponding “check box” filters 634, 636, 638 and 640.

### Data Integration Implementation Compliance Scoring System

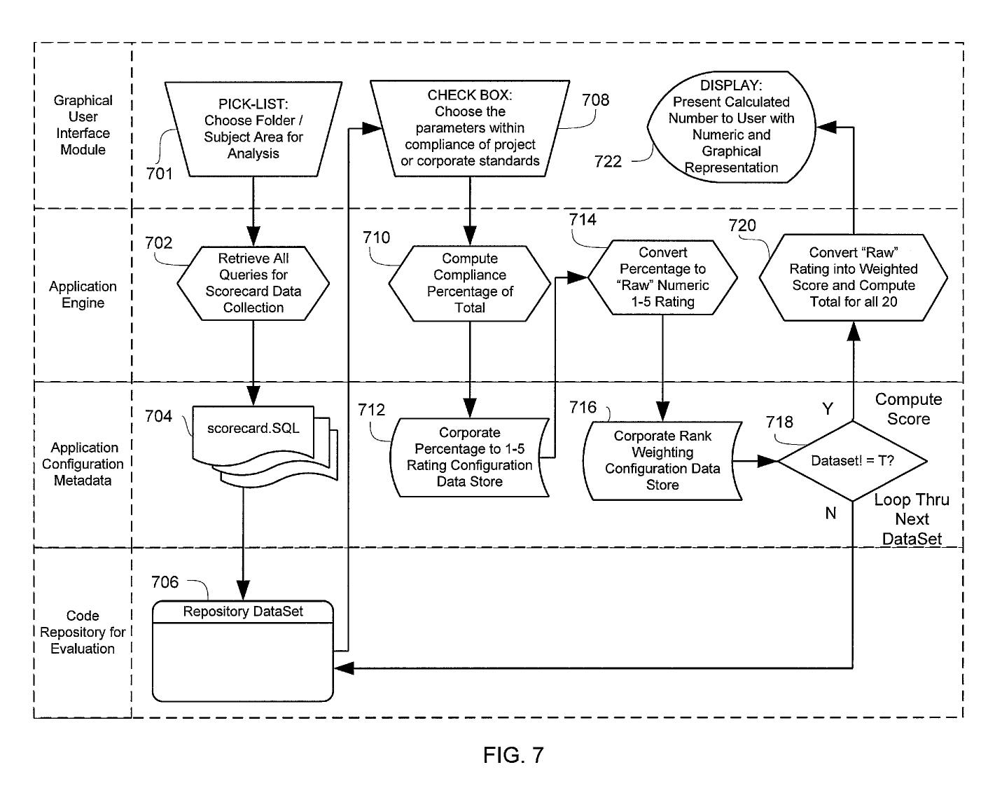

According to an aspect of the invention, there is provided a process and system for evaluating or scoring a data integration implementation for compliance and adherence to best practices. An exemplary process and system according to an embodiment of the invention will now be described with reference to FIGS. 7-12.

Specific areas considered in an exemplary compliance management process and system according to the invention, which may, for example, be applied in the context of an Informatica implementation, are as follows:
1. Naming Standards—Code objects are retrieved from the metadata repository and compared against the current configuration format. As an example, within an Informatica implementation, the following objects may be used to compile scoring: All Transformation Types; Mappings; Workflows; and all tasks within a workflow.
2. Mapping Complexity—Based upon a suggested threshold, only a percentage of mappings within an implementation should be of medium to high complexity. Exceeding this threshold may indicate a lack of compliance to a corporate methodology.
3. Code Documentation—Based upon the percentage of code that has been commented on within the metadata repository, a score is produced and inserted into the overall CMMI-style calculation.
4. File Directory Usage: A series of directories are displayed for end-user analysis and feedback. The following distinct directories are extracted from the metadata repository and a provision is made for the user to provide input or feedback if the retrieved directories are part of the architecture standards or if a developer has failed to use the proper directories for the project. A few of the directory configurations retrieved from the repository may include: Source File Directories; Target File Directories; Bad or Reject File Directories; Parameter Files and their directories; Session Log Directories; Workflow Log Directories. Preferably, a graphical user interface (GUI) may provided for permitting a user to indicate, using, for example, click boxes, incorrect or non-compliant directory structures from a listing of directory structures retrieved from the repository. The user indication of compliant and non-compliant directory configurations becomes an input into the total calculation for the implementation scoring. An application according to an embodiment of the invention may also include a routine to determine if all questions have been answered and all feedback has been retrieved for proper calculation of a summary analysis. Upon validation, the calculation is processed and the results are displayed, preferably in a graphical structure, as will be further detailed below.
5. Duplicate Object Issues: During development, more than one full-time employee or contractor is responsible for coding various objects. There are often times, if not managed properly, duplication of objects occurs. Within this wizard or questionnaire, SQL queries extract data from the metadata repository to find such duplications. When this occurs, the overall CMMI scoring is adversely impacted. Such duplication measured includes: Duplicate Source Definition Object; Duplicate Connection Objects; Duplicate Session Log Files; Duplicate Workflow Log Files.
6. User Setup: Implementations that lack proper onboarding activities tend to experience more development and testing pains than organizations and implementations that provide users with a consistent and repeatable setup process. Part of that process is capturing data about the user for metadata purposes. Within the metadata repository, SQL queries review user data to determine if descriptions and contact information has been appropriately gathered. If not, this negatively impacts the overall scoring generated by a wizard according to an embodiment of the invention.
7. Execution Standards: One final set of scoring elements is factored into the overall CMMI-style figure. (1) The number of code executions (within Informatica they are workflow executions) relative to the complexity ratings and (2) average durations and throughput for sessions and workflows are determined relative to standard benchmarks either specified within the query template or derived from averages that exist within the metadata repository.

As will be further explained below, the compliance management application may provide a number of screens or wizards, each having panels and each of the panels within the wizard prompt the user for information and generate compliance management data which may be provided as numeric score ranging between 1 and 5. That score is then weighted across the implementation based upon pre-defined “importance” limits (which can be customized by the application user/owner). If one organization deems naming standards unimportant, it can become less of a factor in the overall score for the implementation's or organization's maturity rating. In accordance with the invention, the exemplary application wizards take into account that no two organizations are exactly alike, not only within their implementation and software but also in their focus on quality and the level of importance placed upon this quality measures.

FIG. 7 is a “swim lane” format illustration of an overview of the process steps and corresponding system components (indicated on the left hand side of the drawing) for accomplishing an implementation compliance scorecard according to the invention. At step 701, within an application GUI, a user selects the folder or subject area within which analysis will occur. This list is pre-populated with a dataset from the code repository that is compiled at regular intervals by the application engine using a query stored within the Application Configuration Metadata (process not shown on this diagram). Step 701 is preferably shared with several other processes within the toolset and is a shared unit of code within the application.

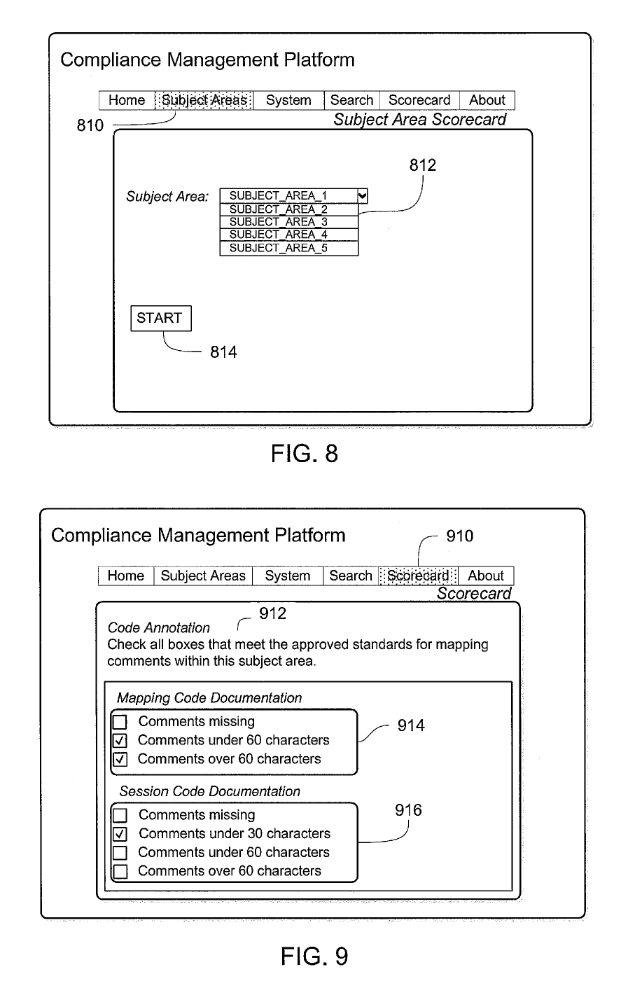

FIG. 8 depicts an exemplary GUI screen for permitting a user to select a particular subject area, which represents a code segment to be evaluated, from a drop down list. The application engine associates the selected Subject Area name with the SUBJECT_ID (surrogate key for Subject). The main screen may include a “Subject Areas” navigation control 810 which permits the user to navigate to a screen for inputting a selected subject area. The input may be facilitated by a pull down list or menu 812 which displays a list of available subject matter areas. The user may highlight one or more of the displayed subject areas for selection. A “start” control 814 initiates further processing. Referring again to FIG. 7, at step 702, all queries for scorecard data collection are retrieved after user-selection of a project or subject folder. The application may utilize java script(s) for a given application page, which will use variables and/or parameters to identify data within the query language properties file(s) for decryption. SQL code, preferably resides within this query language properties file in an encrypted state and is tagged with an unencrypted, general term to be referenced by the variables and parameters in the application's java scripting. The application engine will use these variables to retrieve the appropriate and corresponding data from the query properties file and readies it for processing by the general decryption algorithm. As a specific example, the basic syntax of a line of data within the query properties file might appear as follows:

allGroupQuery=
ENC(KXeQRGAPNU4nSVuhn+5euL9+xfdqAe1y6BV7GaqdVAEsPf8
VI+IdH5jDI7f7vNDTCg783TveCpyJ0EJCX+iZ4fQg9ujXtkYqaB
6ZV/kn9W2yGMlYounYRDu1OFjrof6adHT+fy5i6yk= )!

At step 704, the SQL queries identified within step 702 are decrypted then compiled with the corresponding SUBJECT_ID associated with the Subject Folder or Project Folder being analyzed. Queries are logically ordered based upon execution time and end-user interaction within the score card process. Once the query set has been identified, each query string needs to pass through a decryption process (all code between the application and the repository are stored in an encrypted state) and are then compiled with a new WHERE clause (“where subject_id=202”). For example, the newly compiled queries might be of the form:

```
  allGroupQuery = select group_id, group_name, group_desc from
opb_groups where subject_id = :subject_id
:subject_id becomes replaced with “202” to create the final query string:
  allGroupQuery = select group_id, group_name, group_desc from
opb_groups where subject_id = 202
```

At step 706, queries, preferably approximately 20 in number, are sent via Java Database Connectivity (JDBC) protocol to the database application which maintains the code repository. Each query has a results set that is compiled into a data array for processing by the application. These queries perform a series of counts and groupings of counts for display to the end user. For example, the data sets may include:
A.) Mapping Code Documentation
B.) Session Code Documentation
C.) Workflow Code Documentation
D.) Transformation Code Documentation
E.) Connection Naming Standards
F.) Source File Directory Structures
G.) Target File Directory Structures
H.) Bad File Directory Structures
I.) Session Log File Directory Structures
J.) Workflow Log File Directory Structures
K.) Parameter File References
L.) Mapping Naming Standards
M.) Session Naming Standards
N.) Workflow Naming Standards
O.) Transformation Naming Standards
P.) Mapping Complexity Breakdown
Q.) Duplicate Session Log Files
R.) Duplicate Workflow Log Files
S.) Session Log Files Do Not Match Session Names
T.) Workflow Log Files Do Not Match Workflow Names

The application engine facilitates a JDBC connection to the database for execution of each unit of code. Data sets A through T begin to generate. Each data set will consist of counts and grouping descriptions. For example, the mapping code documentation query will return the result set shown in TABLE 1:

TABLE 1

| Mapping | |
|---|---|
| Count | Mapping Description |
| 20 | “Comments Missing” |
| 9 | “Comments under 60 characters” |
| 36 | “Comments over 60 characters” |

At step 708, upon completion of the first datasets and interpretation by the application engine, data are sent to the end-user for review. For each compliance factor, a set of gradation categories are represented in the GUI, preferably displayed with empty check boxes for users to select compliant categories and leave unselected non-compliant categories. Unselected categories will thus represent unacceptable variations of corporate or project standards. Category object counts are internally correlated to the category names themselves, but in order to simplify user input, end-users will preferably not be able to see exact counts of the categories. These figures will be internally stored in memory and utilized for calculation of totals. Results sets, like the one in Table 1, are returned to the user interface without the mapping count field visible. An exemplary resulting screen image is depicted in FIG. 9. The user may navigate to the scorecard display by activating an appropriate scorecard navigation control 910 which may be in the form of a tab (shown as activated in FIG. 9). An instruction panel 912 directs the user to check appropriate boxes corresponding to approved standards. For each compliance factor, a series of gradation categories are displayed for selection by the user. In the illustrated example, for the mapping code documentation compliance factor, a listing 914 of three gradation categories is displayed: 1) Comments missing; 2) Comments under 60 characters; and 3) Comments over 60 characters. Similarly, for the session code documentation compliance factor, a listing 916 of four gradation categories is displayed. The end user may review each of the categories displayed and select those categories that are within compliance ranges for the project, subject area, or implementation using a “check box” control or similar interface.

Referring again to FIG. 7, at step 710, based upon the total count of objects the query intends to analyze, checked categories, more specifically the counts internally associated with them, will be summarized and divided by the total number of objects for the query. This generates the appropriate percentage passed out of step 710. The application engine will correlate the selection on the screen to the counts stored within memory on the server. For this example, as shown by the checked boxes in FIG. 9 for Mapping Counts, the user has selected the second and third categories as being within the compliance range. Therefore, 9+36 mappings, or a total of 45 mappings are in compliance. Within the subject or project folder, there are a total of 65 mappings (20+9+36) for purposes of computing the percentage of total. The 45 compliant mappings divided by 65 total mappings equates to a compliance percentage of 69.2%.

At step 712, moving to the application configuration metadata store, the application engine retrieves the internal mapping for the computed percentages and correlates them to a rating system appropriate for a given compliance factor. Preferably, mapping may correspond to the 1-5 rating system patterned off of the CMMI process improvement framework as described above. Each query and resulting data set will have a unique, and configurable, scale or tolerance range. Stored with the application configuration metadata, there exists a section of code or reference data from which a conversion to a raw score can be derived. This particular configuration parameter is preferably housed directly within java script written to handle the scorecard execution, calculation, and data aggregation. TABLE 2 below demonstrates the basic percentage to raw score conversion:

TABLE 2

| Step 1212 | Step 1212 | |
|---|---|---|
| Percentage | Percentage Upper | Scorecard |
| Lower Limit | Limit | Raw Score |
| 100% | 100% | 5 |
| 90.00001% | 99.99% | 4 |
| 75.00001% | 90% | 3 |
| 40.00001% | 75% | 2 |
| 0% | 40% | 1 |

This information becomes available within memory and/or code to facilitate conversion into a score based upon the CMMI model for implementation maturity. The line of code that stores this initial conversion is:

/*Group1 : 100, >90, >75, >40, <40*/
var group1Scoring = [“scMapping”, “scSession”, “scWorkflow”,
“scTransform”];

At step 714, the percentage to scoring correlation will facilitate the calculation or derivation of an internal “raw” score for each data set. Based upon the checks placed within the boxes for a given metric, a percentage will yield a scoring 1 through 5. For example, if 90% of total objects for a given metric are checked indicating that they are within compliance, a score of 4 or 5 will typically be derived based upon the percentage to raw score translation. Using the conversion data made available within 714, values from 710 are passed into code and evaluated for conversion into the raw score. For example, based upon the 69.2% percentage score in 710 and the data available in 712, the scorecard raw score for the Mapping Documentation will have a value of 2 (per Table 2 above). Sample code yielding these results is similar to below code:

```
function getRating(elId, elPercentage){
  if (group1Scoring.contains(elId)){
    if(elPercentage == 100){
      return 5;
  } else if(elPercentage > 90) {
    return 4;
  } else if(elPercentage > 75) {
    return 3;
  } else if(elPercentage > 40) {
    return 2;
  } else {
    return 1;
  }
```

At step 716, once a raw score is calculated, the corporate rank weighting configurations are retrieved from the metadata storage and used to convert the raw score into its weighted equivalent based upon the internal configuration of the application. While the configuration according to the invention aims to weight raw scores based upon its broad knowledge of the Extract, Transform, Load (ETL) and custom coding environments, it will be recognized by those of ordinary skill in the art that the configuration metadata is configurable based upon client specifications. Weighting factors may be stored within the configuration metadata, for example, in a setup.properties file, as:

targetThresh=6
LoadPlanThresh=3
#scorecard weight
scMapping_weight = .75, 10, Mapping Code Documentation
scSession_weight = .75, 20, Session Code Documentations
.....
....

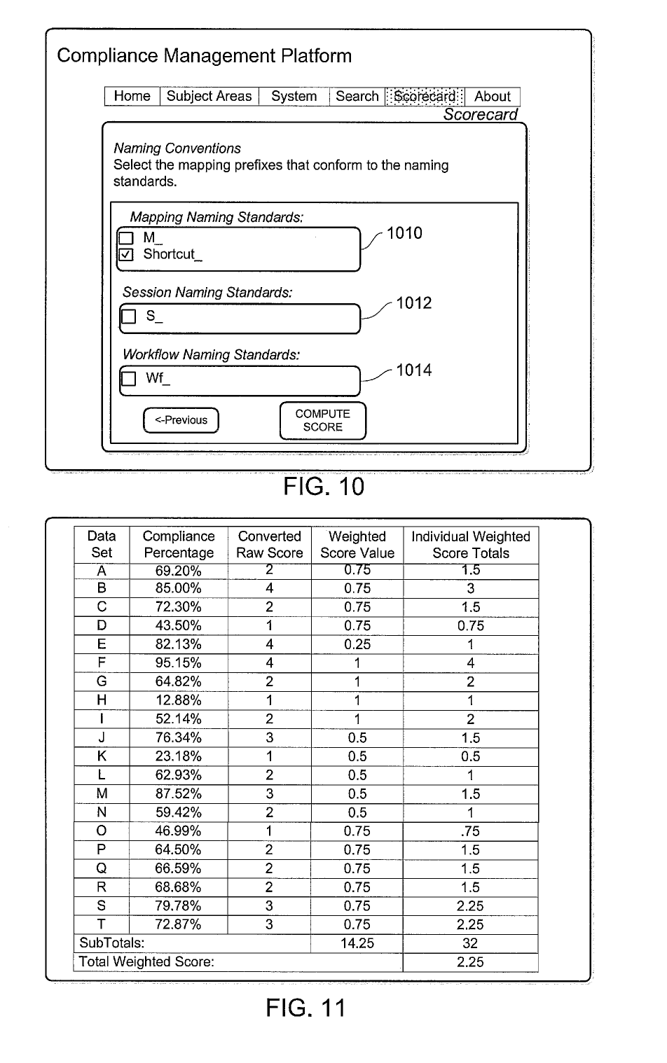

All of the weightings in this text file are preferably dynamically pulled into the application during scorecard calculation and can be modified at any time. At step 718, if the final data set has not been processed, a loop occurs in the process flow diagram and all steps 710 through 718 are repeated until all metrics have been reviewed and compliance check boxes have been completed. The results of this loop are new windows and/or sections of windows emerge for the end user to evaluate, such as the display depicted in FIG. 10. Here, naming convention-related compliance factors are evaluated by allowing user-selection of conforming naming standards. Category sets for compliance factors such as mapping naming standards (1010), session naming standards (1012) and workflow naming standards (1014) are developed. Once all compliance factors are evaluated, the end-user will click the application button: “COMPUTE SCORE”. This will aggregate all 20 scores and derive a weighted score based upon the standard weighted average calculation below:

Implementation ScoreCard Final Computation Result=Sum of All Weighted Scores/Sum of All Weightings

Sum of all weighted scores=(A*Weighting of A)+(B*Weighting of B)+[and so on]

Sum of all Weightings=Weighting of A+Weighting of B+Weighting of C[and so on]

To demonstrate the calculation of all components, FIG. 11 shows how the values for each step compute the overall implementation score. With additional reference to FIG. 7, the “compliance percentage” is calculated at step 710, “converted raw score” at step 714, “weighted scoring value” at step 718 and “individual weighted score totals” at step 720.

Implementation ScoreCard Final Computation Result = Sum of All
Weighted Scores/Sum of All Weightings
Sum of all weighted scores = 32
Sum of all Weightings = 14.25
Implementation Scorecard Final Computation Result = 2.25

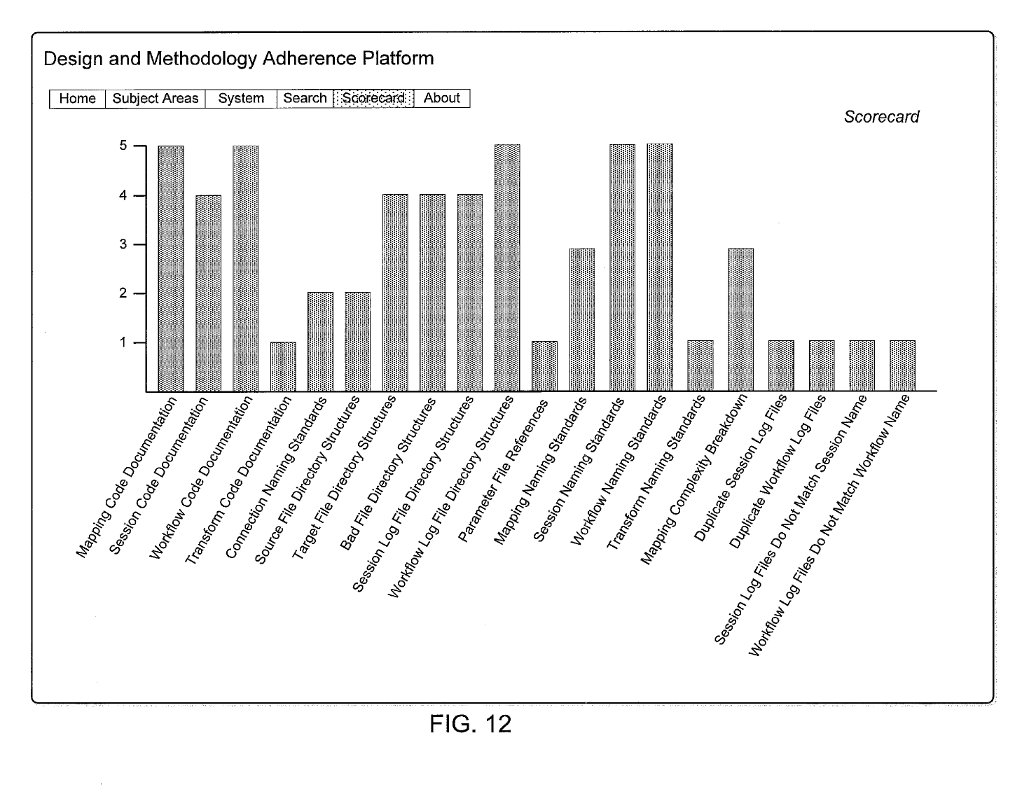

At step 722, the results of the analysis are displayed to the user, preferably in the form of a chart or graph, such as that shown in FIG. 12, along with exact numbers for the end-user to review project strengths and weaknesses. Numbers for all calculations and displays are preferably maintained internally and retrievable by the user as needed. This will allow users to focus upon the immediate needs of the implementation to achieve a higher compliance score during their next review process.

### Customization of Weightings

It will be recognized that one or more weightings can be customized within an application according to an embodiment of the present invention. This customization of weightings can occur at two distinct levels: (1) within the application configuration metadata and (2) within the java script that handles data between the repository database and the presentation layer. For example, to modify the java script, edits for lower and upper limits for raw score conversions would occur within the java script that manages that particular set of pages. To modify the application configuration metadata, a skilled resource may open the core configurable java properties file(s) and modify the weightings for the scorecard. This can be done with any file editor such as Notepad, Wordpad, or Textpad. Upon completion of the configuration properties edit, the web server application must be stopped and restarted with the newly added values for this weighting configuration. Without it, previous values will continue to be leveraged by the application engine.

### Mapping Complexity Evaluation System

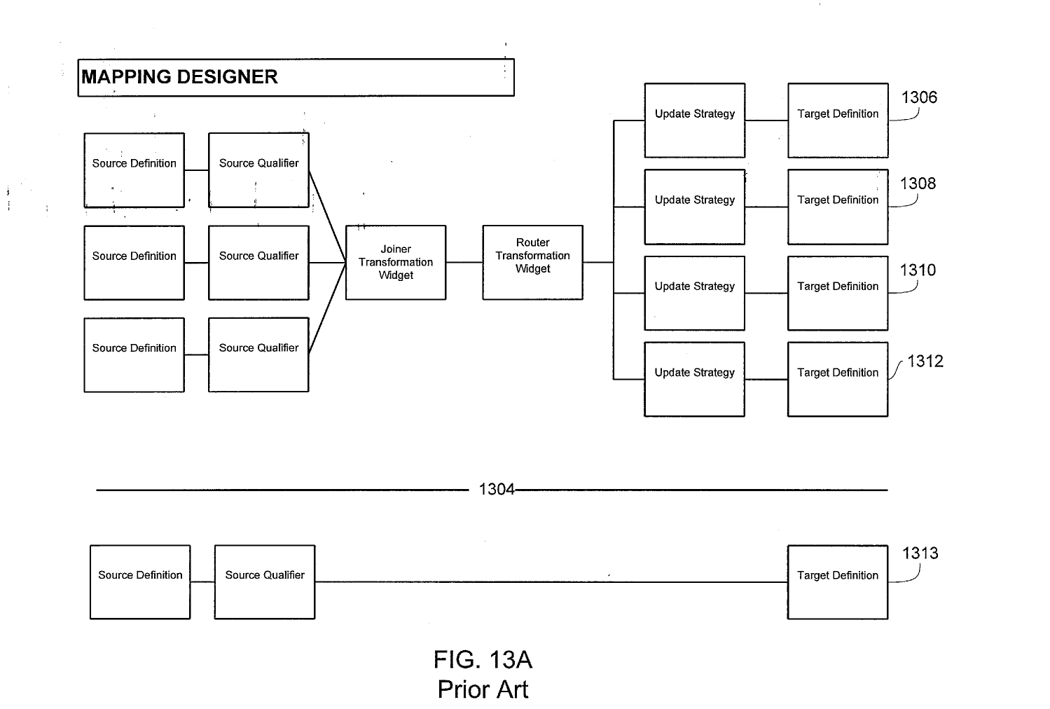

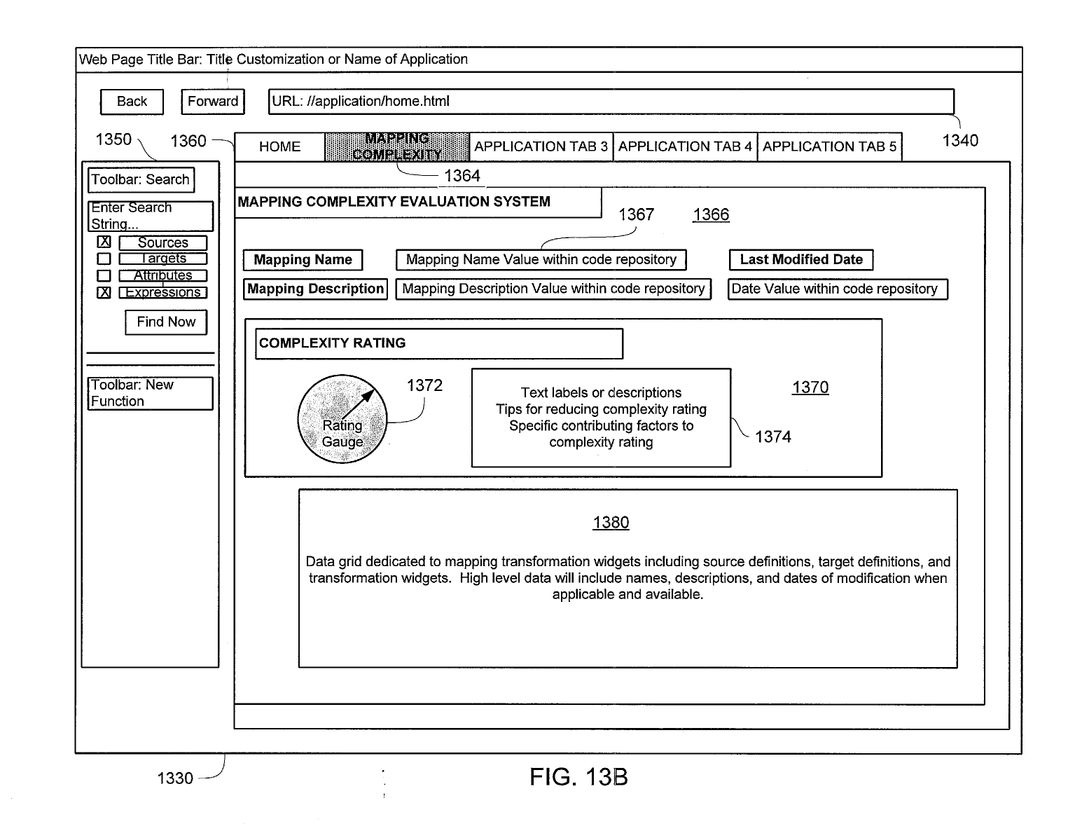

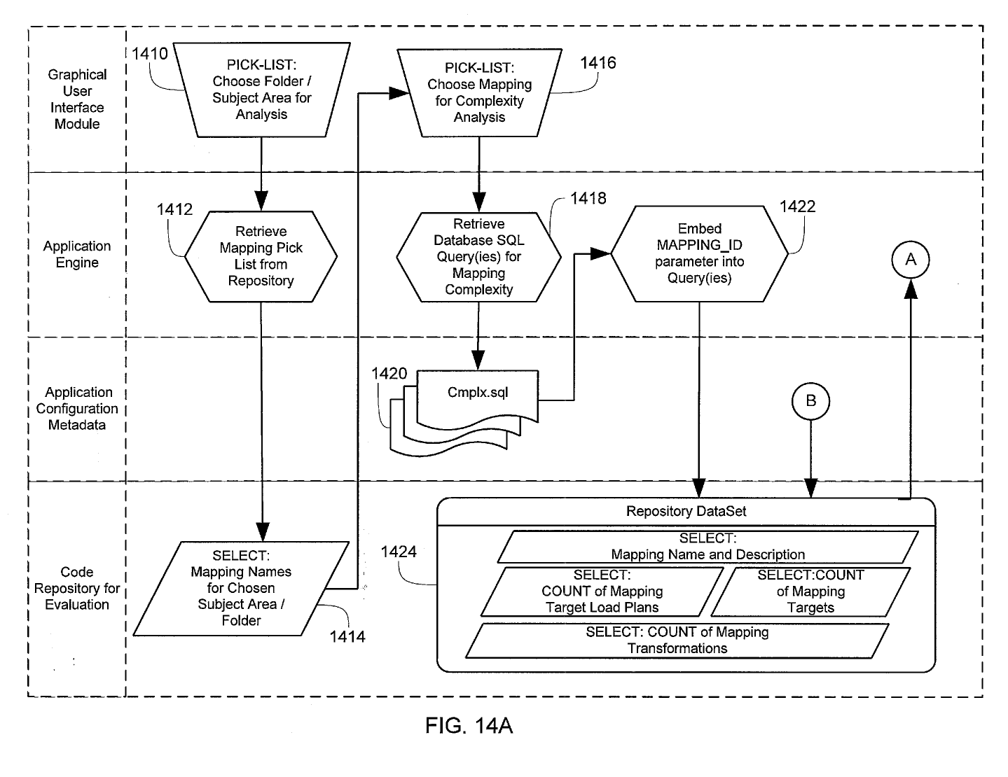

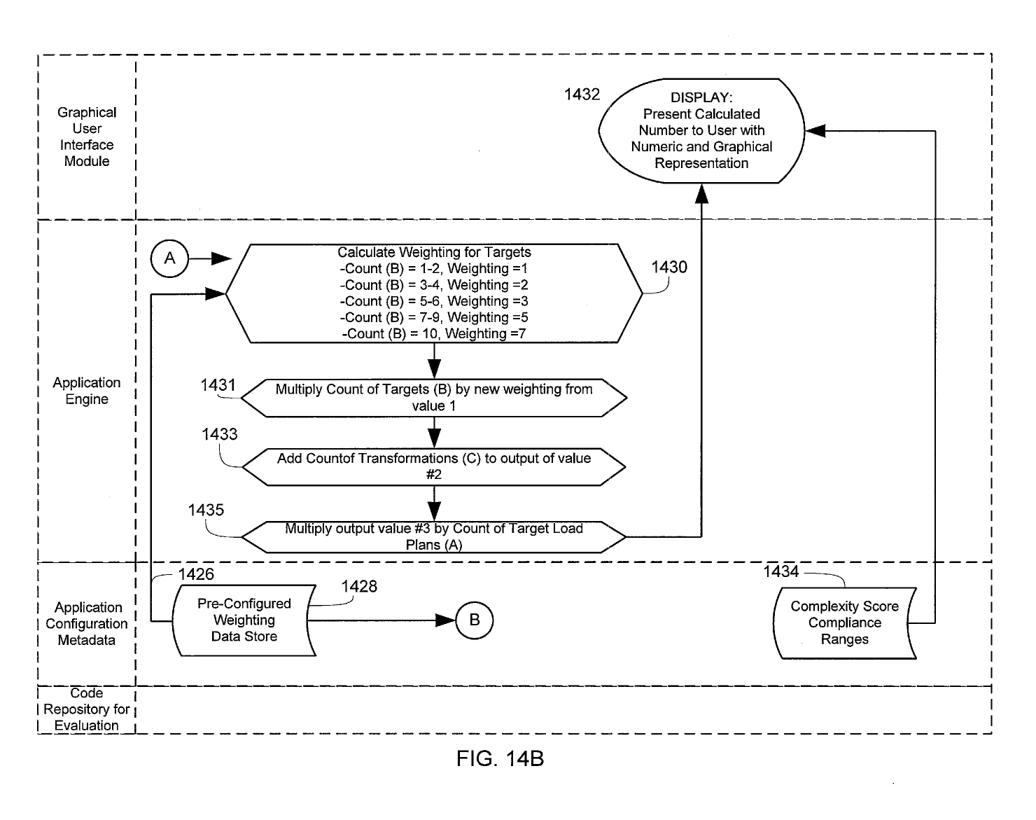

As will be recognized by those of ordinary skill in the art, mapping complexity is one compliance factor that may be evaluated in the above-described compliance scorecard implementation according to the present invention. In accordance with another aspect of the invention, a unique and novel mapping complexity evaluation process and system are provided. An exemplary mapping complexity evaluation process and system, according to the invention, will now be described with reference to FIGS. 13A, 13B, 14A and 14B.

FIG. 13A is a depiction of a mapping scheme displayed by known data integration platforms, such as Informatica. The illustration is provided as an aid to understanding the context of mapping complexity as a compliance factor in data integration implementations. For example, a source-to-target data mapping, represented by a “Mapping” in Informatica's Mapping Designer tool and PowerCenter system, contains a Mapping Description. Each widget or transformation used inside the mapping also contains a Transformation Description. These data elements are housed within separate tables in the metadata repository. The SQL queries join these tables together “to tell a story” of the history and lineage of the code. Transformations are ordered logically to outline the data flow from source to target. The document begins with source definitions and source qualifiers, continues with transformation objects that manipulate data elements, and end with target definitions that show where the data is being pushed.

FIG. 13B is an exemplary graphical user interface for a mapping complexity scoring feature according to a preferred embodiment of the invention. The display screen is generally referenced as 1330. The display includes a web navigation bar 1340 for permitting a user to specify an interne URL corresponding to a web-based service supporting a mapping complexity scoring application according to a present embodiment of the invention, as well as forward and back navigation buttons. A search section 1350 allows user input for searching sources, targets, attributes or other expressions in the database. An application section 1360 includes a tab-based navigation area for permitting a user to select a number of sub-applications provided as parts of the main application, with each sub-application corresponding to one of the tab areas. A mapping complexity tab area 1364 is shown activated as a result of a user having selected, using a user-input selection devices such as a mouse or keyboard, a mapping complexity scoring sub-application according to a preferred embodiment of the present invention. The mapping complexity scoring area display area 1366 includes a mapping name input field 1367 for permitting user input of a mapping name corresponding to the mapping for which a complexity score is desired. In response to user input of the mapping name, a mapping description is displayed in a mapping description field and a last modified date is also displayed in a last modified date field. A mapping complexity rating section 1370 of the display provides a graphic representation of complexity, using, for example, a complexity gauge 1372, which may include a color gradation (i.e., from green to yellow to red) representing degrees (i.e., acceptable, marginally acceptable/unacceptable, and unacceptable, respectively) of mapping complexity for the selecting mapping. The mapping complexity rating section may include a mapping complexity guidance information area 1374 for providing text labels or descriptions or tips for reducing complexity rating or listing specific contributing factors to complexity rating. A data grid section 1380 may also be provided in which is displayed a data grid dedicated to mapping transformation widgets including source definitions, target definitions, and transformation widgets. High level data will include names, descriptions, and dates of modification when applicable and available.

FIGS. 14A and 14B illustrates the background technical processes executed by an application according to the invention. As will be recognized by those of ordinary skill in the art, the depicted process steps are preferably performed by the applications or modules shown on the left hand side of the drawing. As shown in FIGS. 14A and 14B, at step 1410, using a GUI, a user navigates to a mapping complexity main screen and selects the folder or subject area within which analysis will occur. The GUI may include a pick list which is pre-populated with a dataset from the code repository. The pick list may be compiled at regular intervals by the application engine using a query stored within the application configuration file.

At step 1412, using the Subject Area data point selected in step 1410, a SQL query is customized to extract from the code repository all Mapping IDs and Mapping Names contained within the Folder/Subject Area chosen. By the action of selecting a Subject Area value, the application engine parses a query with a new WHERE clause (“where subject_id=202”) and establishes a JDBC connection to the database for execution of the code.

At step 1414, a customized SQL query executes within the code repository database and creates a dataset comprised of Mapping_ID and Mapping_Name from that database. This dataset is then delivered to the GUI tool. In this step, All Mapping_IDs and Mapping_Names (including the paired value of m_SAMPLE_MAPPING_CODE|101) are extracted from the code repository. At step 1416, using the dataset from step 1414, Mapping_ID is concealed from the GUI view and a pick list containing only Mapping Name is made visible to the user. The Mapping_Name for complexity analysis is now selected. All Mapping_Name data from the extract in step 1416 are compiled in memory and displayed in pick list format on the left side of the screen. The user may then click the appropriate control on the screen to select the mapping name “m_SAMPLE_MAPPING_CODE”.

It should be noted that the association of Mapping_ID to Mapping_Name is maintained by the GUI and the application engine in a data array stored within memory similar to the layout in the table above. Mapping_ID is an indexed surrogate key for Mapping_Name within the code repository. While users will make a selection based upon the meaningfulness of the Mapping_Name, it is preferably Mapping_ID that becomes embedded into customized SQL queries for data retrieval from the code repository database. The usage of the surrogate key field greatly improves the performance of all queries submitted to the repository database. If the Mapping_Name were used, query time would be, on a relative basis, far longer than with the surrogate key usage.

At step 1418, once a Mapping_Name is selected, the application engine sends a request to the application configuration metadata for the SQL query or queries affiliated with the mapping complexity evaluation process, as further described below. At step 1420, based upon the internal Query identifier, the application configuration metadata is reviewed and the proper query is extracted for use by the application engine. From within the Application Configuration Metadata, the SQL queries tagged appropriately within the application engine properties files are stored in memory and decrypted for execution. At step 1422, the application engine parses the query or queries retrieved by step 1420 and does a string replacement to embed the Mapping_ID value associated with the Mapping_Name selected by the user in step 1416. The application engine makes the association between the Mapping_Name selected and the Mapping_ID maintained within memory. This Mapping_ID is embedded into the recalled query or set of queries in step 1422 and submitted to the database across a JDBC connection. A new WHERE clause exists in the query passed to the database: “where Mapping_ID=101”.

At step 1424, the application engine connects to the code repository database using JDBC connectivity protocols and submits the newly parsed query or queries to the database for data retrieval. Queries are executed by the host repository database and datasets are returned. The dataset can be broken into four distinct sections:
General Information: Attributes of the Mapping are returned for description purposes and potential categorical applications. The general information may or may not be used within the existing computation of the complexity evaluation. As a specific example, the following general information may be returned:
   Mapping_Name: m_SAMPLE_MAPPING_CODE
   Mapping_Description: “This is a sample mapping for testing purposes.”
   Is_Valid: 0 (0=Valid, 1=Invalid)
(A) Count of Mapping Target Load Plans: A Target Load Plan (or Order) is defined by the number of independent data streams contained within a mapping. A data stream is simplistically defined as a set of sources that are directly tied/related to a set of target definitions. A mapping can have one to many Target Load Plans. While mappings can have multiple target load plans/orders, that unit's complexity will increase exponentially given the multitude of start and end points which most frequently are used to count the number of potential error locations. As a specific example, based upon the mapping illustration in FIG. 13A and the bolded line 1304 drawn through the mapping image, there exists no intersection between two sets of transformations. Because no transformation widget linkage occurs across line 1304, the code repository will store this information for processing purposes. The server that executes this code must understand the order by which these independent segments are executed. To communicate that effectively to the server, this information is obtained by the ETL tool and stored in a code repository database table separate from other mapping related information. This step will use the MappingID associated with the mapping name being analyzed and retrieve the maximum LOAD_PLAN number from that database table. For the given example above, the Target Load table will contain two records respectively identifying the work stream above line 1304 and the work stream below line 1304. To produce the count of 2 Target Load Plans for this mapping name, a SQL query is executed that properly joins information about the mapping to the database table that stores information about the target load plans and their sequence of execution. A database function such as COUNT( ) is used to retrieve the number of records stored in this table for the relevant mappingName. That produces a count of 2 Target Load Plans for this particular example. [CountA=2]
(B) Count of Mapping Target Definitions: Each unit of code or mapping contains a set of source definitions and target definitions. As the number of target definitions grows within one unit of code, that code becomes increasingly complex in its design, implementation, testing, and maintenance. To illustrate how known systems such as Informatica, show target definitions, depicted in FIG. 13 are five Target Definitions within the mapping under inspection, numbered 1306, 1308, 1310, 1312 and 1313. These icons or boxes are typically denoted with a designated coloring to stand out amongst the other transformation types. Additionally, each target definition has a corresponding record in the code repository specific to a target definition within the mapping process. For this particular example, the code repository will contain five distinct records that represent the graphical image of objects 1306, 1308, 1310, 1312, and 1314. The present invention's code stored within the Application Configuration Metadata will find the record or series of records for these target definitions, apply a database function COUNT( ) on the target definition record, and aggregate that value for analysis. This code will return a value of “5” for the mapping example in FIG. 13A. [Count B=5]
(C) Count of Mapping Transformation Objects: A transformation is an object within a mapping that creates data, alters data according to specifically coded instructions within the transformation, or pushes data through the mapping. There are over 30 transformation types within Informatica alone and each has its own level of complexity for implementation. Usage of highly complex transformations will increase the complexity score at a higher rate than standard, less complex, transformation types. In general though, as the number of transformations increases (regardless of individual complexity), so does the complexity of the mapping code. In this specific example, using a conventional prior art tool, such as Informatica PowerCenter's Mapping Designer, mapping transformation object count can only be determined manually where a user must visually count each of the transformations on the page to achieve a count of 31. In accordance with an embodiment of the invention, the application performs this count in an automated fashion, as will be explained below, and therefore eliminates the manual effort associated with known implementations such as Informatica which requires opening the Mapping Designer application and visually counting the number of transformation objects within a particular mapping. According to the invention, during development, each transformation widget added to a data mapping process will be logged as a data record in a code repository. These elements contain linkage to the Mapping Name within which it is contained in a series of other database tables. Furthermore, data elements or attributes used to delineate a transformation widget's complexity, in this scenario its TRANSFORMATION_TYPE (Aggregator, Joiner, Expression, etc.), data will be stored in additional tables. To perform the proper calculation, these transformation widget tables are correlated via database join functions to retrieve the Transformation widget type information as well as basic information allowing it to relate back to the mapping it is contained within. The TYPE field is used downstream to weight the transformation widget count based upon pre-configured complexity scores. For a standard mapping process with all weightings equal to 1 (the standard), the SQL code stored within the Application Configuration Metadata will return a database COUNT( ) value of 31 for the mapping example in FIG. 13A. [CountC=31]

Referring again to FIGS. 14A and 14B, at step 1428, pre-configured weightings from the Application Configuration Metadata for Transformation Types, as further described below, can be applied at this stage of the process. Highly complex transformation types increase the score at a faster rate (for example: 2 or 3 times their total count within the mapping) than relatively simplistic transformation types (almost always 1 times their total count). Based upon an analysis of transformation types, in accordance with a present embodiment of the invention, there may be two transformations that have a higher weighting than all of the other standard transformation types which have a weighting of 1 (meaning a multiplication factor of 1 which is not necessary to code for). Preferably, normalizer and SAP transformation types each have a weighting of 3. As a result, CountC is adjusted accordingly. Removing these two transformations from the original count and weighting each as 3, CountC now equals 35:

WeightedCountC:31−2=29+(2[transformations]*3[weighting score])=35

At step 1426, using data embedded within the Application Configuration Metadata, weightings are applied to the counts of target definitions to accurately measure the complexity score for coding, testing, and maintaining a unit of work. This step is called within the complexity computation and will be referenced first in this documentation. Based upon the value of CountB, a weighting is returned from the metadata that corresponds to its impact to complexity. For a CountB=5, the weighting is 3. [target_weighting=3]

At step 1430, using a combination of the database server processing capacity and the application engine, the complexity score is computed according to the following equation, depicted in steps 1431, 1433 and 1435 in FIG. 14B:

Complexity Score=A*((B*Weighting)+Weighted C)

Where A equals the Target Load Plans, B equals Target Definitions, C equals Transformations. Drawing from the specific example above: through variable replacement, the resulting calculation appears as follows:

Complexity Score=2*((5*3)+35)=100

At step 1432, general information and the complexity scoring value resulting from 1430, 1431, 1433 and 1435 are returned to the GUI front-end using a series of data grids and visualization APIs. The end user is now presented with actionable information. At step 1434, information relating to the compliance ranges for the complexity score may be retrieved from the application configuration metadata. The information may be displayed in a series of data grids or gauges that visualize the complexity score in the context of the compliance range. For example, a gauge or meter having red, yellow and green zones may be depicted with an indicator pointing to the red zone for a complexity evaluation that is above the compliance range and pointing to the green zone for a complexity evaluation that is within the compliance range.

Those of ordinary skill in the art will recognize that the features of the invention are not limited to the mapping complexity examples described above. In addition to Informatica data integration, source to target data mapping concepts apply to other platforms. For example, Ab Initio calls them “graphs”; IBM's DataStage calls this a “job” or “job sequence”; Oracle's PL/SQL uses the terms “procedures” or “packages.” For a given coding language, there exist standards and guidelines for writing code to accomplish data mappings, transformations, and translations in an efficient and logical manner and it will be understood that the inventive features described herein are applicable to coding techniques on other platforms and in other languages. Other such tools include, but not limited to, Business Objects's Data Integrator, SAS's Data Integration Studio, Prevasive's data integration platform, Ab Initio, DataWatch Monarch, Pentaho, Oracle Warehouse Builder, Data Migrator, Clover ETL, to name a few.

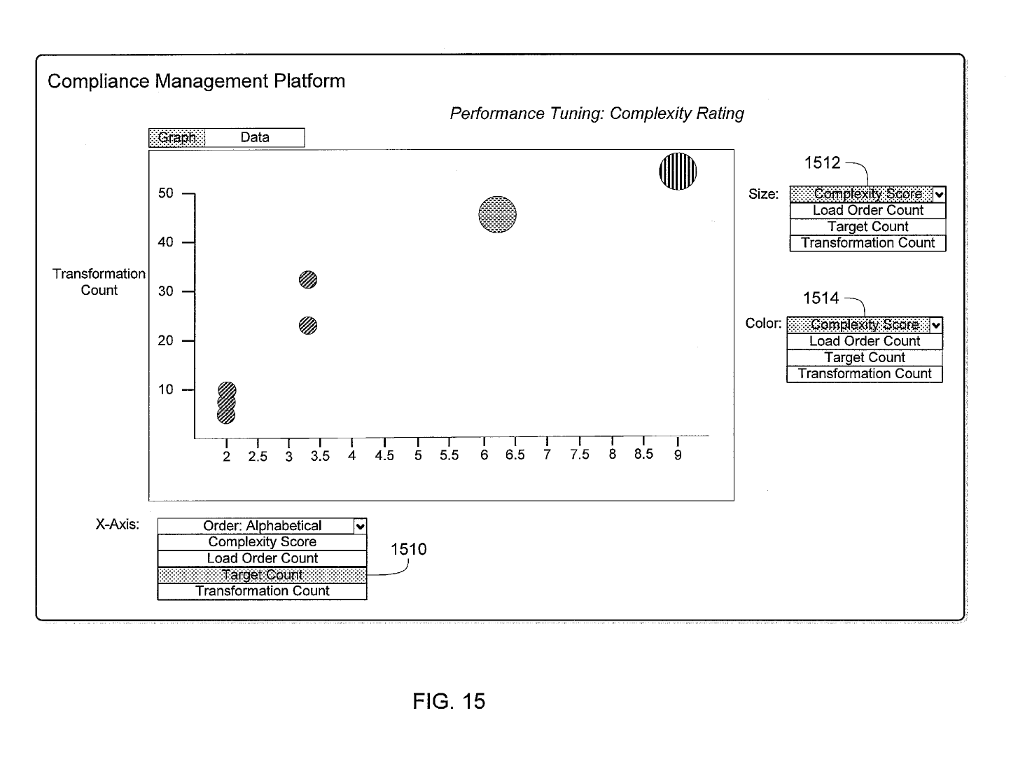

In accordance with another aspect of the invention, complexity ratings for a group of mappings can be displayed to the user by way of a a graphical representation, such as a heat map for the complexity rating system for a grouping of mappings (loosely defined as all mappings within a given folder or subject area in the application) as depicted in FIG. 15. A sorting control 1510 allows the user to select among a number of parameters equated to the X-axis on the chart, such as alphabetical order, complexity score, load order count, target count (shown activated) and transformation count. In addition, a size control 1512 is provided to permit the user to visualize a selected parameter for each mapping by a corresponding size of a display element, in this case a circle. Similarly, a color control 1514 permits the user to visualize a selected parameter for each mapping by a corresponding color of a display element. The different patterns in the circles displayed in FIG. 15 correspond to different colors. It will be recognized that size and color of the displayed circles can increase as complexity increases so that a user can quickly determine anomalous mappings and determine steps needed for complexity reduction for those mappings. In FIG. 15, it can be seen that the user has selected the bottom panel with “Target Count” inside the box. If a user selects one of the other five items from the drop-down menu, the chart will dynamically adjust to realign the plotted data points based upon the new slice of information. This allows the user to adjust the view based upon his or her investigation for compliance level and adherence to best practices. For example, if “Load Order Count” were selected, the plotted points will line up on the X-axis based upon the number of Target Load Plans that have been inserted into the mapping. Any plotted point appearing on the X-axis to the right of “2” should be re-evaluated and some redesign may be necessary. This can be done with any of the data elements offered within this report.

In addition to the dashboard reporting for an individual source-to-target mapping work unit, there can be provided an aggregate report for all mappings within a given folder/subject area/project. This charting device plots each mapping's complexity score within a pre-defined grouping onto a chart and assigns each score with a “heat indicator”, where the highest complexity object in the grouping is assigned the largest plot on the graph (with the darkest, preferably “red” coloring) and the least complex object in the grouping being assigned the smallest plot and “coolest” color, preferably blue.

### Transformation Widget and Task Attribute Configuration Management System

According to another feature of the invention, a transformation and workflow task attribute configuration process permits a user to quickly review transformations and workflow tasks and make comparisons. In keeping with the OLTP versus OLAP database modeling concepts, platform queries have been constructed to denormalize the view of major coding elements and generate additional attributes and metrics based upon seemingly disparate table structures. A series of metadata repository tables are assigned to Informatica's PowerCenter Designer application. Likewise, a separate set of metadata repository tables are used to facilitate Informatica's PowerCenter Workflow Manager application. The combined database tables in the metadata repository create a snowflake schema of data elements, attributes, and metrics at varying levels of granularity, some of which would not make logical sense if displayed in conjunction with elements at a different level of granularity. Here again the repository queries reduce the complexity of joining these varying data elements into a single view.

Most mature metadata repository structures adhere to a data modeling principle known in the art as database normalization. This database structure ensures that the database is designed to support general purpose querying, increased data integrity, and performance of inserts, updates, and deletes. By nature, these metadata repository databases are modeled in a normalized fashion to support the basic constructs of an OLTP system or application. Each saved key stroke or mouse click performed by a developer, team lead, or administrator is captured by the metadata repository and it therefore needs to be modeled/constructed/designed in a manner appropriate for its unique function. However, this database design principle does not work well for online analytical processing (OLAP) applications that are best supported by denormalized database structures.

For more granular level reporting supporting common business intelligence and decision support objectives, complex metadata repository queries have been constructed to provide a virtual OLAP database view of the OLTP database structures. Code objects, such as workflow tasks and transformation widgets, have numerous configuration attributes associated with them. These attributes are represented by multiple records or rows across many tables within the metadata repository's OLTP normalized database structures. Reviewing and comparing attributes and their configurations across like objects is often difficult and could require a series of complicated queries, manual data snapshots, and manipulation based upon visual data comparison or external tools such as Microsoft's Excel LOOKUP( ) functions. Likewise, using the front-end tool such as Informatica's Mapping Designer or Workflow Manager, these attribute configurations span a wide variety of screens and sub-panels at all levels within the code base, making side-by-side code comparisons impossible in the existing tool sets. The application, according to the invention, eliminates the need for such cumbersome, error-prone, and manual activities by a highly skilled resource with strong knowledge of the relationships of data within the metadata repository. Instead, SQL queries act as “virtual views” to pivot data as columns rather than rows as the extraction occurs at the database level. As a result, one code object becomes one record easily sorted and displayed with other like objects. For example, a lookup transformation widget has over 25 configurable attributes. Each lookup transformation created will therefore have over 25 records in the OLTP normalized database structure. To compare two lookup transformations, over 50 records representing each set of attributes must be extracted and manipulated in a fashion that will align corresponding attributes across each transformation. Instead, the application according to the present invention will extract only two records from the database structure, one for each lookup transformation in the comparison. Rows in the OLTP normalized database are converted into a denormalized columnar view of the data. This new view of the metadata repository is more easily filtered and compared for analytical purposes. New insights are readily visible across configurable attributes and correlations to performance may be derived from this view.

The following describes the detailed processes required to display normalized, multiple record-based attribute configuration data within a code repository into a flattened, de-normalized report merging all attribute records onto one data line for immediate review. The majority of the aggregation and compression of data occurs within the SQL queries designed to pivot data appropriately.

For any given code base, there are a series of widgets and workflow tasks that serve as building blocks to larger units of code, mappings and workflows respectively. For one such ETL product, Informatica PowerCenter, these widgets are referred to as transformations, or transformation types, which are embedded within a larger unit of work called a mapping. To analyze all transformation types within a single technology view or graphical user interface is impossible within the existing toolset. A user must manually open each mapping using the Mapping Designer tool for a subject/project folder and review a series of tabs for a transformation type's configuration. Typically, manually written or typed notes, via a standard word processing application, must be taken with regards to the configuration of specific attributes and this process needs to be repeated again and again until all code is reviewed. This initial operation could take days and weeks given the potential volume of code.

The invention intends to replace this manual and complex analytical process with a new, query-based approach that is limited only to the response time of the SQL query at the relational database level. This allows an application user to save days, possibly weeks, of time. For this example, the user would like to compare the attribute configuration for two lookup transformations within the current Subject Area folder.

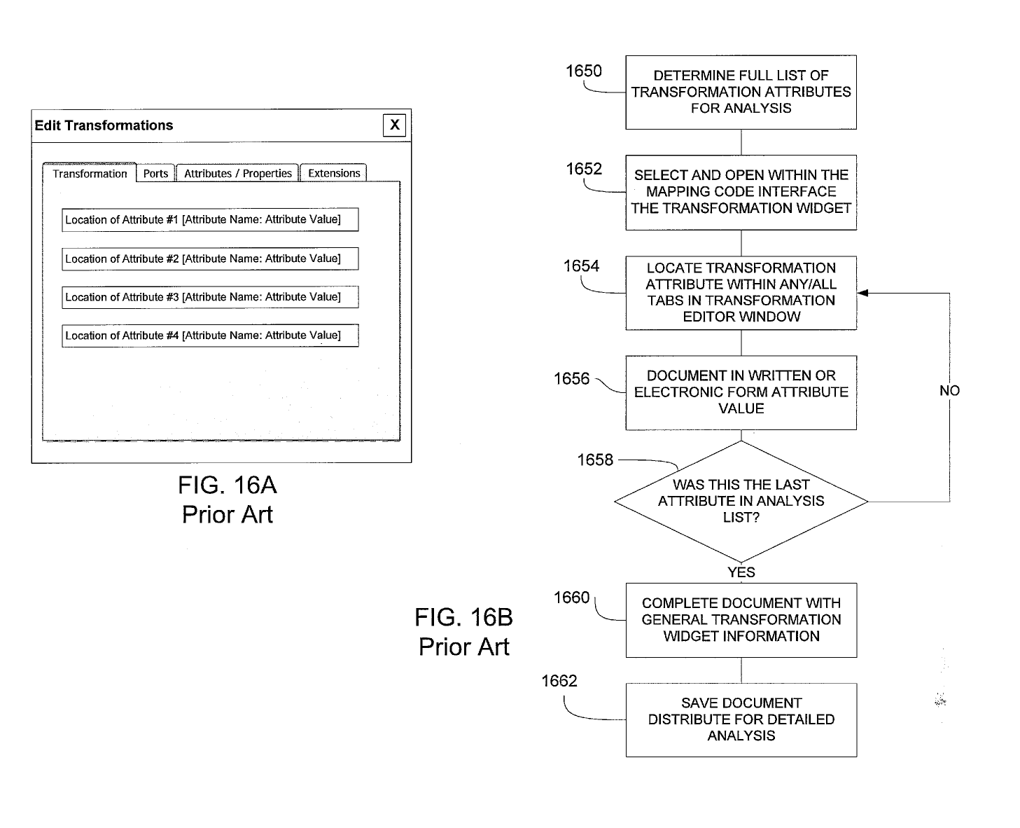

An exemplary process according to the invention will now be explained with reference to FIGS. 16A, 16B, 17A, 17B, 18 and 19.

FIG. 16A illustrates a user interface screen provided in known prior art systems (i.e., Informatica) for retrieving transformation widget and workflow task attribute information. As can be seen, the tab-based retrieval does not provide for an integrated view of widget and workflow task attribute information. In other words, for each transformation widget or workflow, a user must undertake the onerous manual process of retrieving attributes by navigating to the “Transformations” tab, noting the attribute locations and other information, and recording such (for example, using hand-written notes). FIG. 16B illustrates a manual process for retrieving transformation widget and workflow attribute information as required by prior art systems. At step 1650, the user must determine extent of the full list of transformation attributes desired to be reported. At step 1652, the user must select and open within a mapping code interface, such as that depicted in FIG. 16A, the transformation widget and workflow interface. At step 1654, the user must toggle across the tabs in the user interface to retrieve the desired attribute information for a given transformation widget or workflow. At step 1656, the user must document manually in written form the retrieved information. The process steps are repeated as illustrated in steps 1658-1662 until all desired attributes have been retrieved and documented. As will be recognized, the above process is time-consuming and requires a great deal of manual effort by the user.

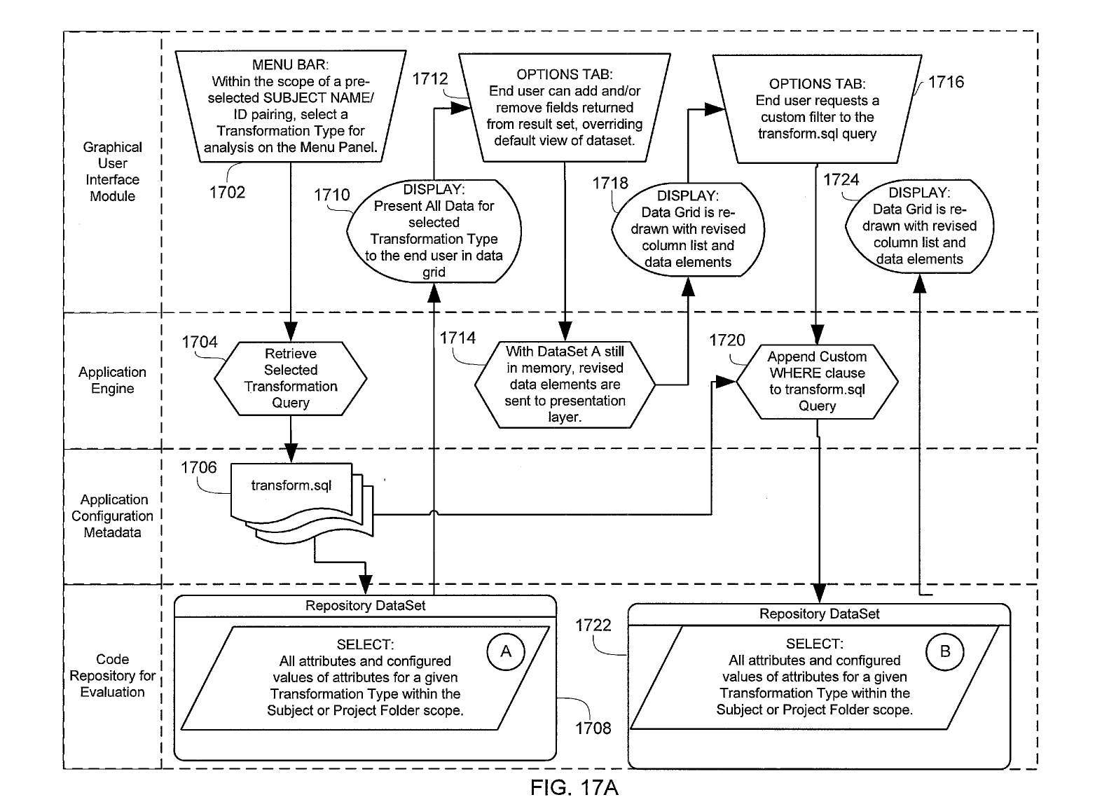

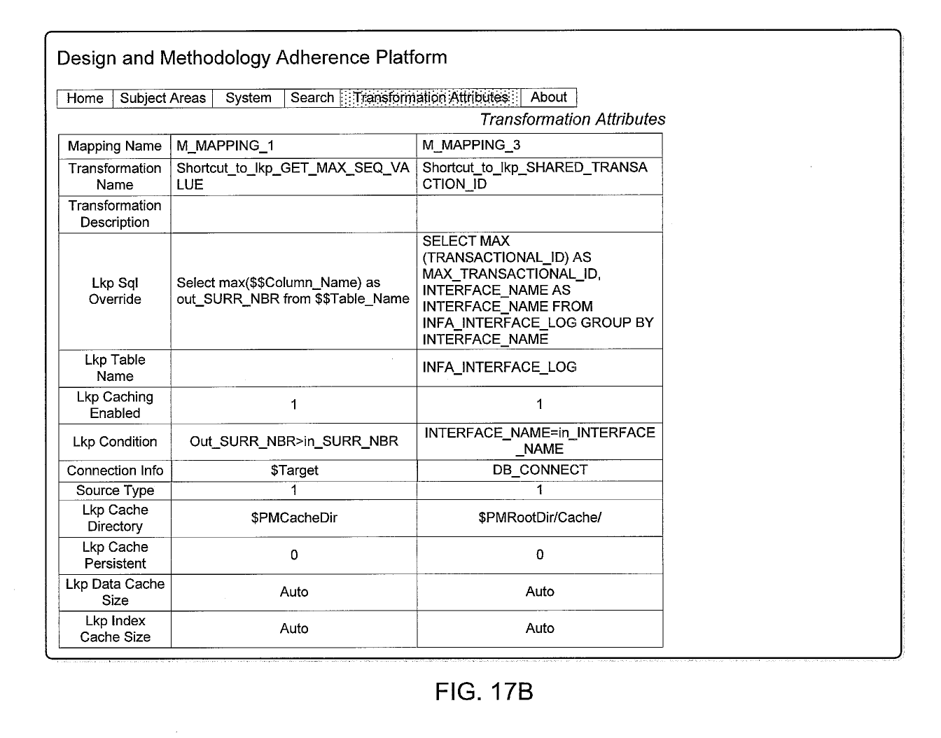

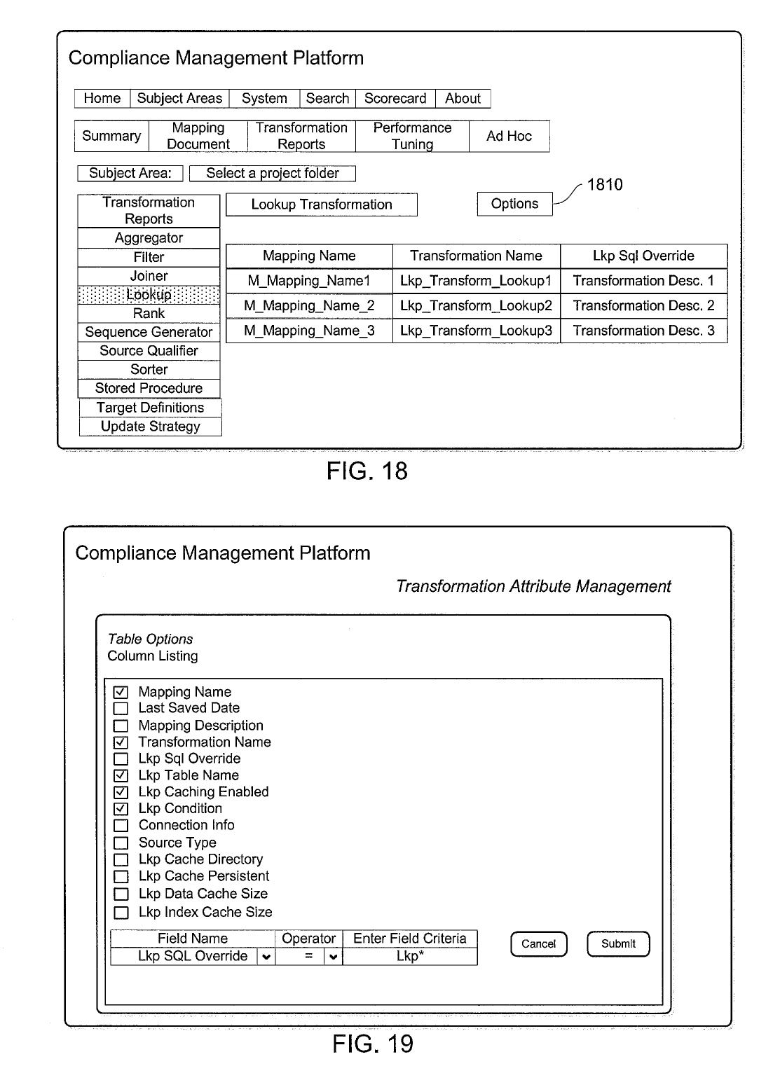

In order to address the above shortcomings in known data integration platforms, a present embodiment of an aspect of the invention provides a process for generating an integrated view of attribute information. Referring to FIG. 17A, at step 1702, within the application GUI, a user can navigate to the transformation attribute configuration reporting section. This section is a sub-section of the subject or project folder section of the application. While all of the string substitutions for SUBJECT_ID will occur within this process as well, it is an assumed part of this process flow, given that it has been detailed above with respect to the compliance scoring system and mapping complexity aspects of the invention. Within the sub-section, a number, preferably 10 of the most commonly used transformation types are available to the end user for selection purposes. The user, upon clicking a particular transformation type, will send a call to the application engine for query identification and, subsequently, data retrieval. For example, the user may navigate to the Transformation Reports sub-section of the Subject Area page views for a screen display as depicted in FIG. 18. Within the main landing page for that sub-section of reports, the user should click on the “Lookup Procedure” link, either in the main body of the page or off to the left-hand side.

At step 1704, based upon the user selection, the application engine will select from the properties files within the application configuration metadata the associated transformation type query. Based upon the selected transformation type, in this instance the Lookup Procedure, the properties file, Lookup.properties, is selected and the SQL query string is retrieved to memory. For transformation type query sets, each transformation type is contained within its own query. New queries and properties files are selected; it is not new parameters passed into a template query that delineates the categories of data.

At step 1706, the SQL query identified within Step 1704 is decrypted then compiled with the corresponding SUBJECT_ID associated with the scope of the windows a user is navigating. The majority of the complexity of transposing data elements for this process resides within the SQL for a given transformation. The template for this de-normalization of the configurable attributes is preferably implemented as two nested SELECT statements embedded within an outer SELECT that aggregates based upon a MAX( ) function. The nested queries select data and perform RANK( ) functions to eliminate multiple lines for the same attribute. Within the Informatica code repository, there are a total of 27 configurable attributes for the lookup procedure transformation type. However, those of ordinary skill in the art will recognize, for analysis purposes, that the methodology/application may designate fewer, preferably 10, configurable attributes as useful for reporting purposes. If a user wishes to view additional, currently unlisted attributes, a SQL query code change can be performed to add this functionality.

For example, the following is an explanation of known SQL queries that may be used to implement the step 1706 above.
1. Inner-most query: This query serves the most basic function of the overall query: create the proper joins between code repository tables and filter data appropriately. Within this query, there are two main criteria with the WHERE clause:
   OBJECT_TYPE_NAME=‘Lookup Procedure’
   ATTR_ID in (1, 2, 3, 5, 6, 7, 10, 12, 13, 14)
2. RANK Query: The next query uses the inner-most query as its data set for purposes of RANKing attribute configurations. The RANK function, along with its filter within the outer WHERE clause, ensures that the application retrieves only one record per attribute. Some attributes, including SQL Overrides, can expand beyond the constructs of one line of code and therefore will “wrap” to a new line or record within the code repository. Because these reports are mainly considered with the existence of such configuration, knowing that there are multiple lines is not important for the purposes of this report and are therefore excluded from additional aggregation functions.
3. MAX Query: This query serves as a final de-duplication effort prior to final data output. This MAX( ) aggregation query will group the incoming data by Mapping Name and Transformation Instance Name (widget) to ensure only one attribute configuration is displayed per transformation instance. This three-step process flats data stored in a normalized, or multiple-record fashion.

It is difficult from the pseudo-code above to extract exact performance results without reviewing a real-world scenario and the level of effort required for manual review using existing platforms, such as Informatica. In our example, we are studying Lookup Procedure transformation types.Lookups

lkp_GET_MAX_SEQ_VALUE and

lkp_SHARED_TRANSACTION_ID

exist within a specific folder identified for review. This is the view of the transformation object within the Transformation Developer of PowerCenter's Mapping Designer application. To view the attributes of the transformation, a developer will open the object for edit purposes to reveal an “Edit Transformation” screen. This transformation type contains five tabs for configuring 27 different attributes. The tabs are: Transformation, Ports, Properties, Condition, and Metadata Extensions. The key tabs that most developers and quality assurance specialists will review are “Transformation”, “Properties”, and “Condition”. By default editing options, the Transformation tab is opened at time of edit. Three attributes on this screen include “Transformation Name” (depicted next to the “Select transformation” text box), “Transformation Type” and “Description” “Properties” and “Condition” tabs appear as shown in dialog boxes provided by existing systems, such as Informatica. The majority of the configurable attributes appear on the Properties tab. Each Lookup Procedure transformation type contains the same Tab layout and number of configurable attributes. Thus, in existing data integration platforms like Informatica, by application design of the PowerCenter Mapping Designer, there is no ability to open two transformation edit windows simultaneously, navigate to the appropriate tab, and align transformations for side-by-side comparisons or review code for standard corporate, project, or industry standard best practices. Each of the line items in the attribute images above represent another record in the code repository. Thus, it is an aspect of the invention to address this problem by developing a data view that aggregates and compresses all records onto a single line per transformation type, more thorough and efficient code evaluations are possible. For most large-scale implementations, there are, on average, over 40 Lookup Procedure transformations within a folder. To evaluate and document the attribute configurations for these transformations could consume 2-4 days of one full time resource. The information aggregated by the resource is likely to change over time and that analysis would need to be repeated, consuming additional resource time. To search for configured values of a particular type could take even longer. With the query in 1606, data can now be displayed in an integrated fashion as shown in FIG. 17B. It will be recognized that the display now presents all configured attributes without the necessity for the user to click through a variety of screens, tabs, and miscellaneous widgets. For example, the Lkp Sq1 Override parameters are displayed side-by-side whereas with prior art systems, such parameters would have to be retrieved separately for the respective mapping names. The transformation attribute configuration process according to the invention thus saves a tremendous amount of time and also reduces the propensity for errors in an otherwise manual process.

At step 1708, a dataset A is constructed through the use of a JDBC database connection and transmission of the query to the database server. The de-normalizing query from step 1706 is transmitted to the database platform via a JDBC connection string. This data structure and the data contained within are cached for purposes of additional manipulations further downstream in the process (optional by the user). All Lookup Procedure transformations within that folder, either reusable or non-reusable, will appear in the results set.

At step 1710, data in memory is rendered to a data grid for presentation purposes. Only the application default fields are available for display within the initial instantiation of the report or data grid. The illustration in FIG. 17B represents an exemplary the display of transformation attributes according to a present embodiment of the invention. FIG. 18 represents an exemplary output from a Lookup function according to an embodiment of the present invention. Referring again to FIG. 17A, at step 1712, within a transformation's data grid, a control button 1810 exists at the header level entitled “Options” as can be seen on FIG. 18. Clicking this will open a dialog window for the end user to select or unselect (via a series of check boxes) the fields he or she desires on the data grid report. After selecting the desired fields, user clicks “Submit”. Activating this control will open a dialog window containing all of the fields currently available for the Lookup Procedure transformation as shown in FIG. 19. The user may use the check box functionality to unselect those fields not desired and select all the fields to be visible on the next rendering of the data grid and then initiate a further process by activating the “Submit” control on the screen.

At step 1714, because data set A resides in memory, no additional query is required for submission. This greatly improves performance of the application. Instead, the application engine takes the instructions provided by 1714 and sends a revised data set to the graphical user interface. Upon submission, the application engine will realign the fields for presentation within the data grid structure in the center of the page. At step 1716, the data grid is re-drawn to the specifications outlined in step 1714, with the data provided by step 1714. It will be recognized that the data grid will grow wider if more fields are added or reduce in scope if some columns were removed.

At step 1718, at the user's discretion, she/he can perform custom filtering functions within the options tab. At the bottom of the pop-up window, a user can highlight a field to evaluate for a given condition and modify the relational operator of the equation (=, !=, >, <). A user will then click “Submit”. By clicking Options again, the user will see a filter condition appear at the bottom of the pop-up window as shown in FIG. 19. At step 1720, the tasks completed in step 1718 have potentially altered the results set of dataSet A in such a manner that the application engine knows to re-submit the query to the database server. Prior to doing so, the application engine must insert into the SQL query string a new WHERE clause containing the syntax generated from step 1718. More specifically with regard to step 1720, the query is modified and submitted back to the database server for processing. In the example above, the following condition is added to the WHERE clause of the SQL statement:

And Lkp_SQL_Override=‘lkp*’

While this is only an example, if this filter were applied, it is unlikely data will be returned as it is not common for lookups to contain this configuration.

At step 1722, the newly formed SQL query string is submitted to the database platform for data retrieval. The new WHERE condition should have a limiting affect upon the dataset. Dataset B is retrieved for all lookup transformations that have a SQL Override equal to the value above. At step 1724, this newly refreshed data is delivered to the same data grid container that was previously being displayed on the screen. This data grid can be sorted dynamically by clicking column headers in ascending or descending order. The data grid is refreshed with, for this example, zero records in the data grid table.

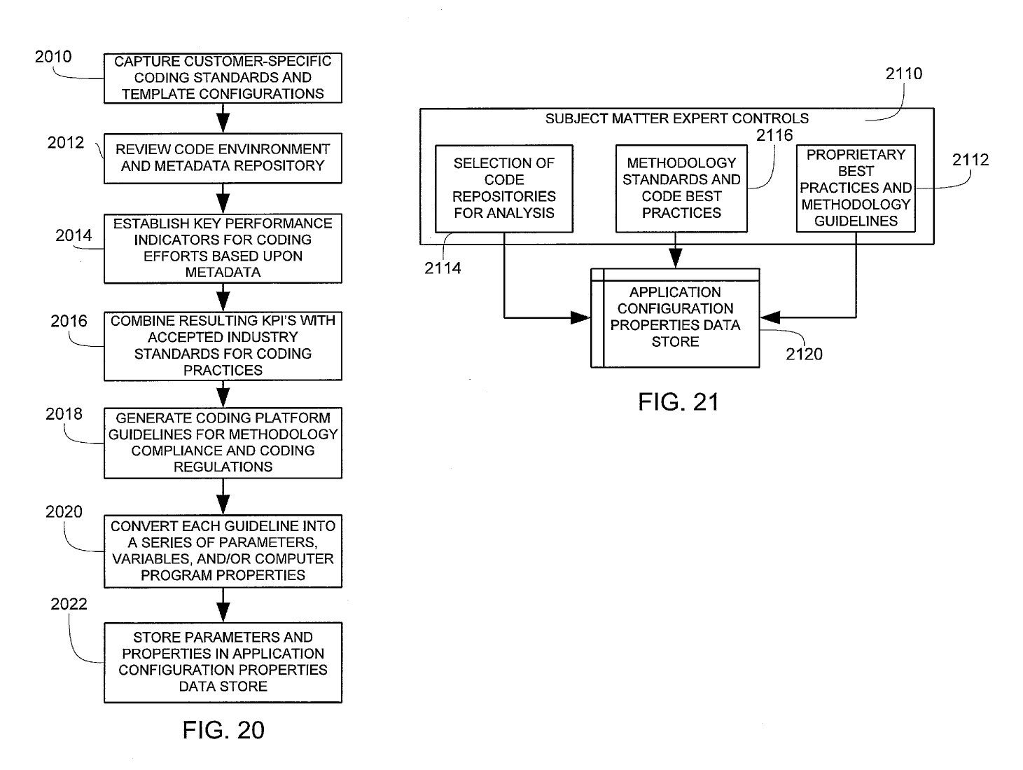

In accordance with another aspect of the invention, further customization of the implementation compliance management may be made for a particular customer. FIG. 20 illustrates a process for customizing the application for a particular client and for developing a guidelines data store for application benchmarking. First, at step 2010, customer-specific coding standards and template configurations and/or other information representing one or more quality management tools is captured. Next, at step 2012, the code environment and metadata repository are reviewed. Key performance indicators (KPI's) for coding efforts, based on the metadata, are established at step 2014. At a further step, 2016, the KPI's and accepted industry standards are combined. Then, at step 2018, coding platform guidelines for methodology adherence and coding regulations are generated. Next, at step 2020, each guideline and other quality management tool is converted into a series of parameters, variables and/or computer program properties and stored, at step 2022, in the application configuration properties data store, for example in a “Setup.properties” file or “database.properties” file.

FIG. 21 illustrates a process for applying quality management tools, which may include subject matter expert controls 2110 in accord with features of the present invention. More specifically, the invention contemplates allowing the use of proprietary best practices and methodologies in evaluating quality in a manner that does not compromise the proprietary nature of such best practices and methodologies. Information representing the proprietary best practices and methodologies 2112 can be stored in the application configuration properties data store in a manner which prevents access by unauthorized users to such information. Similarly, subject matter expert controls 2114 relating to which code repositories are selected for analysis, and conventional methodologies, standards and best practices, 2116, can also be addressed with suitable information being stored in the application configuration properties data store. As described herein, the information stored in the application configuration properties data store 2120 can be utilized to permit users to determine compliance levels, which may incorporate proprietary information, without revealing the specifics of those proprietary methodologies or best practices.

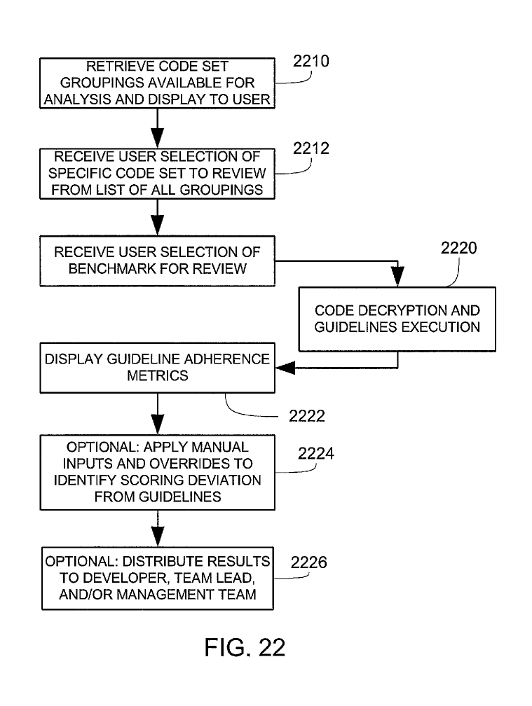

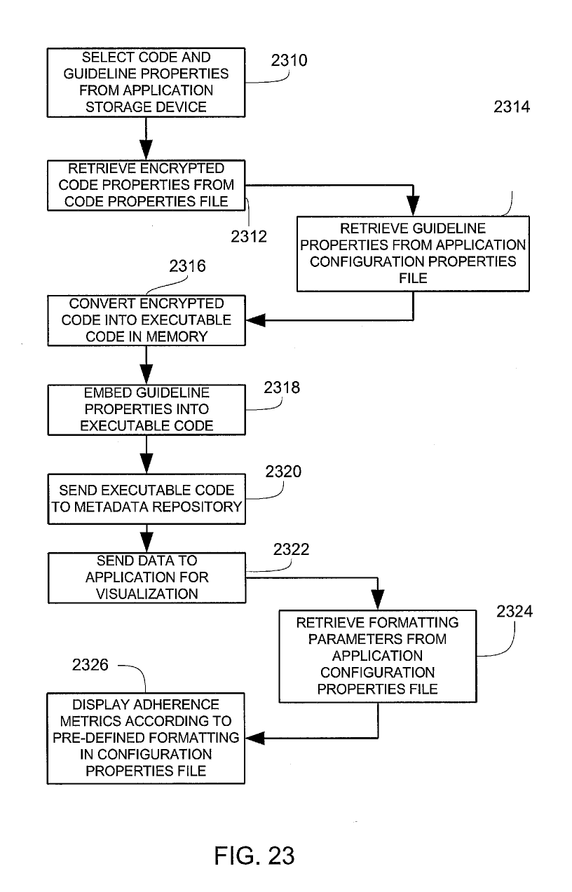

FIGS. 22 and 23 illustrate a process for utilizing encryption in order to preserve proprietary information relating to code itself and guidelines used as a quality management tool. Similar to the process explained with reference to FIG. 20, the user selects a particular code set for review at step 2210 as well as one or more benchmarks or other quality management tools for application to the code selected at step 2212. As shown in FIG. 22, the information is then processed according to a code decryption and guidelines execution block 2220, which is explained in more detail with reference to FIG. 23. Code and guideline properties are selected from the application configuration properties data store in step 2310. The encrypted code is then retrieved from the encrypted code properties file at step 2312. The encrypted code properties file(s) contains all the SQL database code used to retrieve data from the metadata repository. It may be created during the main design process and converted into an encrypted format via an open source java conversion program(s) that requires an appropriate “key” for decryption. The strings of code inside the file remain in an encrypted status until the point of execution where they are decrypted and pushed to the database for processing. The structure may be merely a flat file within the web application's directories. The encrypted code is then converted into executable code in memory at step 2316. At a further step 2318, guideline properties are embedded into the executable code and the code is sent to a metadata repository at step 2320. The data is then sent to the quality management application for visualization at step 2322, wherein formatting parameters are retrieved at step 2324 from the application configuration properties file and then information representing adherence to the quality management tool is displayed at step 2326 on the user's computing device according to the pre-defined formatting specified in the configuration properties file. It will be understood that the foregoing description is merely exemplary and is not intended to limit the scope of the invention, which is set forth in the claims that follow. Similar procedural steps are utilized to generate attribute configuration reporting for all workflow tasks in an implementation.

The foregoing description of implementations has been presented for purposes of illustration and description. It is not exhaustive and does not limit the claimed inventions to the precise form disclosed. Modifications and variations are possible in light of the above description or may be acquired from practicing the invention. The claims and their equivalents define the scope of the invention.

What is claimed is:

1. A computer-implemented method of evaluating a compliance level comprising:
determining a set of compliance factors;
determining a set of gradation categories for each compliance factor;
permitting user selection of one or more gradation categories that are within a compliance range;
determining a compliance level based upon the user-selected gradation categories and the compliance factors.

2. The method of claim 1, further comprising determining a score based upon the CMMI model for implementation maturity.

3. The method of claim 1, further comprising determining a total weighted score for the implementation based upon one or more of the compliance factors.

4. The method of claim 1, further comprising the step of determining a mapping complexity for the implementation.

5. The method of claim 1, further comprising the step of determining a count of mapping code documentation.

6. The method of claim 1, further comprising the step of determining an individual score for each respective compliance factor.

7. The method of claim 6, further comprising applying a weighting factor to at least one of the individual scores to determine the compliance level.

8. The method of claim 1, further comprising the step of displaying the compliance factors and a respective score for each.

9. The method of claim 4, wherein the step of determining a mapping complexity further comprises determining a target load plan count, a mapping target definition count, and a mapping transformation object count.

10. The method of claim 8, further comprising the step of applying a weighting factor to at least one of the counts.
The method of claim 4, further comprising determining a complexity score and a compliance range and designating whether or not the complexity score is within the compliance range on a graphical user interface.

11. The method of claim 4, further comprising the step of displaying a heat map form for visualizing the complexity level.

12. The method of claim 1, further comprising the step of displaying an integrated view of attributes relating to transformations, sessions and workflows.

13. A computer-implemented method of determining mapping complexity in a data integration implementation comprising the steps of:
determining a target load plan count;
determining a target definition count determining a mapping transformation object count;
determining complexity factor based on at least one of the target load plan count, target definition count and mapping transformation object count.

15. The method of claim 12, further comprising applying a weighting factor to at least one of the counts.

16. An apparatus comprising: a processor; a display coupled to the processor; and a computer-readable medium having stored thereon executable instructions that, when executed by the processor, cause the processor to evaluate a compliance level by:
determining a set of compliance factors;
determining a set of gradation categories for each compliance factor;
permitting user selection of one or more gradation categories that are within a compliance range; and
determining a compliance level based upon the user-selected gradation categories and the compliance factors.

17. The apparatus of claim 16, wherein the executable instructions further cause the processor to evaluate the compliance level by determining a total weighted score for the implementation based upon one or more of the compliance factors.

18. The method of claim 16, wherein the executable instructions further cause the processor to evaluate the compliance level by determining a mapping complexity.

19. The method of claim 16, wherein the executable instructions further cause the processor to evaluate the compliance level by determining an individual score for each respective compliance factor and applying a weighting factor to at least one of the individual scores to determine the compliance level.

20. The method of claim 16, wherein the executable instructions further cause the processor to evaluate the compliance level by determining a complexity score and a compliance range and designating whether or not the complexity score is within the compliance range on a graphical user interface.
